(19) United States
(12) Patent Application Publication
(10) Pub. No.: US 2024/0238735 A1
(43) Pub. Date: Jul. 18, 2024

(54) HYDROPHILIC GRAFTING STABILIZING A LAYER OF CRYSTALLINE FRAMEWORK STRUCTURES ON POLYMERIC MEMBRANES, METHOD OF PREPARATION AND USES THEREOF

(71) Applicant: B. G. NEGEV TECHNOLOGIES AND APPLICATIONS LTD., AT BEN-GURION UNIVERSITY, Beer Sheva (IL)

(72) Inventors: Ron KASHER, Midreshet Ben-Gurion (IL); Akshay MODI, Midreshet Ben-Gurion (IL)

(73) Assignee: B. G. NEGEV TECHNOLOGIES AND APPLICATIONS LTD., AT BEN-GURION UNIVERSITY, Beer Sheva (IL)

(21) Appl. No.: 18/563,530

(22) PCT Filed: May 26, 2022
(86) PCT No.: PCT/IL2022/050567

§ 371 Date: Nov. 22, 2023

Related U.S. Application Data
(60) Provisional application No. 63/193,077, filed on May 26, 2021.

(51) Int. Cl. B01D 69/14; B01D 61/14; B01D 69/02; B01D 69/12; B01D 71/02; B01D 71/40; C02F 1/44

(52) U.S. Cl. CPC B01D 69/14111; B01D 69/02; B01D 69/125; B01D 71/0281; B01D 71/401; B01D 61/145; B01D 2325/0283; B01D 2325/04; B01D 2325/06; B01D 2325/20; B01D 2325/26; B01D 2325/36; B01D 2325/48; C02F 1/444

(57) ABSTRACT

Water permeable coated substrates comprising a polymeric substrate in contact with a coating comprising a plurality of particles and a cross-linked polymer are disclosed. Uses of the coated substrates, particularly for water filtration are also disclosed.

### CROSS-REFERENCE TO RELATED APPLICATIONS

This application claims the benefit of priority from U.S. Provisional Patent Application No. 63/193,077 filed on May 26, 2021. The content of the above document is incorporated by reference in its entirety as if fully set forth herein.

### FIELD OF THE INVENTION

The present invention, in some embodiments thereof, relates to coated hydrophilic polymeric substrates and use thereof e.g., for filtration membranes.

### BACKGROUND OF THE INVENTION

Produced water (PW) is a by-product generated in huge amounts by extraction processes in the oil and gas industries. PW typically contains organic and inorganic components and is environmentally hazardous. Therefore, it must be treated using efficient and economical methods prior to discharge to minimize environmental damage or be reclaimed for industrial or agricultural uses as non-potable water, especially in water-stressed regions.

Surface modification is preferred to mitigate membrane fouling in PW treatment due to facile processing and negligible environmental impact. It improves the water flux and oil rejection efficiency of the resulting membrane.

The practical industrial application of membranes for PW treatment requires membranes with good performance and stability. There is, therefore, a need to develop a membrane with excellent antifouling properties providing filtration while maintaining high water flux values and oil rejection efficiency. Various crystalline framework structure nanoparticles, such as ZIF-8 nanoparticles have recently emerged as a promising functional material for modifying membrane surface properties for water treatment applications due to their unique framework structure, ultrahigh specific surface area, tunable size, thermal and chemical stability, facile synthesis protocols, and low production costs. However, the integration of crystalline framework structure nanoparticles into polymeric membranes is challenging due to the limited stability of these nanoparticles as a separating layer during filtration. Accordingly, a hydrophilic membrane modified with crystalline framework structure nanoparticles exhibiting antifouling properties, high water flux, and high oil rejection efficiency during filtration of PW effluents is thus required.

### SUMMARY OF THE INVENTION

The present invention, in some embodiments thereof, relates to hydrophilic polymeric substrate in contact with a composite coating comprising a plurality of crystalline framework structure nano- or micro-particles and a cross-linked polymer, and use thereof e.g., for filtration membranes.

According to an aspect of some embodiments of the present invention there is provided a membrane comprising a polymeric membrane in contact with a coating layer comprising a plurality of crystalline framework structures (CFS) and a hydrogel comprising a cross-linked hydrophilic polymer; the membrane is water permeable.

In one embodiment, the cross-linked hydrophilic polymer comprises a polymer selected from a polyacrylate or a polymethacrylate.

In one embodiment, the CFS comprise nanoparticles.

In one embodiment, the nanoparticles are selected from covalent organic frameworks (COF) nanoparticles and metal-organic frameworks (MOF) nanoparticles.

In one embodiment, an outer surface of the polymeric membrane is chemically modified.

In one embodiment, the chemically modified is by a plurality of surface groups selected from amino and carboxy.

In one embodiment, the polymethacrylate comprises poly (2-(N-3-Sulfopropyl-N,N-dimethyl ammonium)ethyl methacrylate).

In one embodiment, the cross-linked hydrophilic polymer is characterized by a cross-linking degree of about 5%.

In one embodiment, the membrane is characterized by any one of: (i) a water contact angle of about 7°, (ii) a water contact angle of about 21°, (iii) a water contact angle of less than 51°, (iv) a water contact angle being less than a water contact angle of a pristine polymeric membrane.

In one embodiment, the membrane is characterized by a water contact angle being about 13% less than a water contact angle of a pristine polymeric membrane.

In one embodiment, the membrane is characterized by any one of: pure water flow at a flux of about 450 L*m-2h-1bar-1; flux recovery ratio of at about 99% or any combination thereof.

In one embodiment, the polymeric membrane is selected from an ultrafiltration membrane, a nanofiltration membrane, and a microfiltration membrane.

In another aspect, there is provided a coated substrate comprising: a polymeric substrate in contact with a coating comprising a plurality of particles and a cross-linked polymer; wherein the cross-linked polymer is a hydrophilic polymer comprising an acrylate-based polymer; an outer surface of the coating is characterized by a water contact angle of less than about 70°; the cross-linked polymer is characterized by a cross-linking degree between 1 and 20%; the plurality of particles is characterized an average particle size between 1 nm and 20 μm; the coated substrate is water permeable.

In one embodiment, the cross-linked polymer is in a form of a matrix, and wherein the plurality of particles is embedded within or coated by the matrix.

In one embodiment, the cross-linked polymer is characterized by a cross-linking degree between 2 and 10%.

In one embodiment, the polymeric substrate is in a form of a porous water permeable film.

In one embodiment, the water permeable comprises a porosity sufficient to support pure water flow at a flux of at least 10 L*m-2h-1bar-1.

In one embodiment, the porous water permeable film is characterized by an average pore size between 1 and 10 μm.

In one embodiment, the coating is in a form of a continuous layer characterized by a dry thickness between 50 nm and 20 μm.

In one embodiment, the outer surface of the coating is characterized by a negative zeta potential.

In one embodiment, the outer surface of the coating is characterized by a surface roughness of between 10 and 40 nm.

In one embodiment, a weight per weight (w/w) ratio between the particles and the cross-linked polymer within the coating is between 1:10 and 10:1.

In one embodiment, the polymeric substrate comprises a surface modified thermoplastic polymer.

In one embodiment, the surface modified polymer is characterized by at least 10° lower water contact angle, compared to a similar polymeric substrate comprising a pristine thermoplastic polymer.

In one embodiment, the surface modified polymer is characterized by a water contact angle of less than 70°.

In one embodiment, the thermoplastic polymer is selected from the group consisting of: polyacrylonitrile, polyether sulfone, polysulfone, cellulose acetate, polyvinylidene fluoride, polybenzimidazole, polymer of intrinsic microporosity, and a polyolefin, including any combination and any copolymer thereof.

In one embodiment, the outer surface of the coating is characterized by a water contact angle between about 5° and about 50°.

In one embodiment, the particles are crystalline framework structures (CFS) particles.

In one embodiment, the CFS particles comprise a zeolite, a metal-organic frameworks (MOF), and a covalent organic framework (COF).

In one embodiment, the outer surface of the coating is characterized by reduced microbial attachment thereto, compared to a similar substrate devoid of the coating.

In one embodiment, at least 90% of the outer surface is in contact with the coating.

In another aspect, there is provided a membrane comprising the coated substrate of the invention.

In one embodiment, a water filtration membrane is characterized by a thickness of between 10 and 1000 μm.

In one embodiment, the membrane is, characterized by a pore size between 2 nm and 100 nm, optionally wherein the membrane is an ultrafiltration membrane.

In one embodiment, the membrane is characterized by flux recovery ratio of at least 70%.

In one embodiment, the membrane is characterized by oil rejection of at least 95%.

In one embodiment, the membrane retains at least 90% of the initial particles content upon successive water treatment cycles.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a scheme representing dead-end filtration setup. Here, 1: pressure regulator, 2: pressure gauge, 3: stirred cell, 4: membrane with support, 5: magnetic stirrer, and 6: permeate collection vessel

FIG. 2 is a scheme representing the preparation of hydrostable ZIF-8 modified PAN membranes: (1) hydrolysis, to obtain the hydrolyzed PAN membrane (Hy), (2) ZIF-8 nanoparticles grown in situ on the Hy membrane to obtain the HyZif membrane; (3) SBMA/MBA redox grafting on the Hy and HyZif membranes to obtain the HyG and HyZifG membranes, respectively.

FIGS. 3A-B are graphs presenting FTIR spectra of the membrane of the invention (FIG. 3A); and XPS wide spectra of the tested membranes (FIG. 3B). The presence of characteristic functional groups on the membranes confirmed the modifications.

FIGS. 4A-B are graphs presenting XRD spectra of the membrane of the invention (FIG. 4A) and of ZIF-8 nanoparticles (FIG. 4B). The characteristic peaks of the ZIF-8 particles are indicated on the relevant spectra of HyZif and HyZifG membranes (FIG. 4A).

FIGS. 5A-B are images presenting EDX elemental mapping on a cross-section (FIG. 5A) and on the surface (FIG. 5B) of the HyZifG membrane. The appearance of the elemental map of Zn confirms the presence of the ZIF-8 nanoparticles on the membrane.

FIG. 6 is a bra graph presenting water contact angle values, measured by the sessile drop method on the dry membranes.

FIGS. 7A-B are AFM micrograph (FIG. 7A) and a bar graph (FIG. 7B) presenting the surface roughness of membranes measured by AFM. RRMS values are provided next to each membrane name. Scan area 5×5 μm. At least three readings from each membrane were measured to report the RRMS value as mean±S.D. FIG. 7A presents an AFM micrograph of an exemplary HyZifG membrane, having RRMS value of 24.6±2.0 nm.

FIG. 8 is a bar graph showing pure water permeance of the prepared membranes. Higher permeance values were recorded for the modified membranes compared to the pristine PAN membrane.

FIG. 9 is a graph showing antifouling filtration experiments with the PAN, Hy, HyG, and HyZifG membranes using simulated oilfield PW (see solution composition in Table 1). The tests were conducted under a stable initial flux (100 L·m⁻²·h⁻¹) by adjusting the transmembrane pressure (0.1-0.3 bar). The average transmembrane pressures (in bar) for the different membranes were 0.25 (PAN), 0.18 (Hy), 0.15 (HyG), and 0.22 (HyZifG). Here, W denotes the water filtration step, and PW represents the simulated oilfield PW filtration step.

FIG. 10 is a scheme showing the antifouling mechanism of HyZifG membrane in the treatment of the oilfield PW. The insert shows a proposed structure for the chemical stability of the ZIF-8 layer via coordination interactions between the negatively charged sulfonate groups and the positively charged ZIF-8 nanoparticles.

FIGS. 11A-D and FIGS. 11A1-D1 are SEM micrographs of the PAN (11A, 11A1), Hy (11C, 11C1), HyG (11A, 11A1), and HyZifG (11D, 11D1) membranes before and after fouling in oilfield PW treatment. FIGS. 11A, 11B, 11C and 11D present the SEM micrographs of the PAN, Hy, HyG, and HyZifG membranes before fouling. FIGS. 11A1, 11B1, 11C1 and 11D1 present the SEM micrographs of the PAN, Hy, HyG, and HyZifG membranes after fouling. The HyZifG membrane showed negligible attachment of foulants on the surface, whereas the foulant attachment on the surface of the pristine PAN membrane was significantly higher. The results support the good antifouling performance of the HyZifG membrane. The scale bar in all panels represents 5 μm.

FIG. 12 is a graph presenting FTIR spectra of fresh and used (after fouling experiments) HyZifG membrane, exhibiting the stability of the modification layer on the membrane surface.

FIG. 13 is a graph presenting Zeta potential analysis (in 1 mM KCl solution) of the PAN, Hy, and HyG membranes.

FIGS. 14A-C are SEM micrographs of the PAN (FIG. 14A), HyZif (FIG. 14B), and HyZifG (FIG. 14C) membranes showing the surface morphology of different membranes disclosed herein, as compared to the pristine PAN membrane.

FIG. 15A-D are micrographs, FTIR and XRD spectra of the synthesized COF-300 nanoparticles. FIGS. 15A-B are SEM images of the COF-300 nanoparticles showing their oblong shape. FIG. 15C is a FTIR spectrum of the COF-300 nanoparticles exhibiting their characteristic peaks at 1625 cm⁻¹ (attributed to imine C═N stretching) and 2926 cm⁻¹ (attributed to alkene C—H stretching from imine), hence confirming their successful synthesis. FIG. 15D is a XRD pattern of the COF-300 nanoparticles.

FIG. 16 is a micrograph showing a SEM image of the COF-300 nanoparticles deposited on the hydrolyzed PAN membrane.

FIG. 17 is a scheme showing preparation of hydrogel-stabilized ZIF-67-modified PAN membranes: (Step 1) hydrolysis, (Step 2) ZIF-67 nanoparticle in situ growth, (Step 3) UV-graft polymerization of SBMA-co-MBA.

FIG. 18 is a bar graph showing water drop contact angles of the pristine PAN and modified membranes of the invention.

FIGS. 19A-F are SEM analyses of the surface morphology of (FIG. 19A) PAN, (FIG. 19B) Hy, (FIG. 19C) HyG, (FIG. 19D-E) HyZIF67, and (FIG. 19F) HyZIF67G membranes.

FIGS. 20A-B are graphs showing antifouling performance of pristine PAN, HyG (10 min UV) and HyZIF67G membranes measured by filtering 100 ppm BSA in synthetic secondary wastewater (SSWW) solution at a pH of 6.4-6.7 (FIG. 20A) and at a pH of 7.2-7.7 (FIG. 20B).

FIGS. 21A-B are SEM analyses of the surface morphology of SEM images of PAN (FIG. 21A) and HyZIF67G membranes (FIG. 21B) after BSA/SSWW fouling (as disclosed in the Example 4).

FIG. 22. Long-term antifouling filtration experiments of [symbol] pristine PAN, and [symbol] HyZIF67G membranes filtering BSA in synthetic secondary wastewater (SSWW) solution.

### DETAILED DESCRIPTION

The present invention, in some embodiments thereof, relates to coated polymeric substrates comprising a coating layer composed of crystalline framework structure nanoparticles and a hydrophilic cross-linked polymer (e.g., in a form of a hydrogel). Furthermore, the present invention, in some embodiments thereof, relates to use of the coated polymeric substrate as a water filtration membrane.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

The present invention is based, inter alia, on the recognition that a cross-linked hydrophilic acrylate-based polymer may be utilized to stably entrap crystalline framework structure particles (e.g., COF and/or MOF nanoparticles), to obtain a stable composite membrane suitable for water filtration. In some embodiments, the cross-linked hydrophilic acrylate-based polymer applied on top of the crystalline framework structure nanoparticle layer in contact with a polymeric substrate (e.g., in a form of a porous polymeric membrane). In some embodiments, the coated polymeric substrate disclosed herein is characterized by desired intrinsic properties, including, but not limited to, enhanced or substantially the same hydrophilicity (reflected by a water contact angle), chemical and/or mechanical stability, thermal stability, sufficient water permeability and significantly reduced fouling property, as compared to the uncoated (or pristine) polymeric substrate. In some embodiments, the coated polymeric substrate disclosed herein is characterized by desired intrinsic properties suitable for use thereof as a membrane (e.g., water filtration membrane).

As used herein, the term “chemical stability” is meant to refer to a property of the disclosed coated polymeric substrate which can withstand and function under harsh operating and cleaning conditions, e.g., high backpressure, strong oxidants, bases, and acids (which are usually applied for cleaning of the industrial filtration membranes), high density of microorganisms (e.g., biological foulants), or, in the context of thermal stability, high temperatures.

According to an aspect of the present invention, there is provided a coated substrate comprising a polymeric substrate in contact with a coating; the coating comprises a plurality of particles and a cross-linked polymer; the cross-linked polymer is a hydrophilic water-wettable polymer and is characterized by a cross-linking degree between 1 and 20%; the plurality of particles is characterized by an average particle size between 1 nm and 20 μm; and wherein the coated substrate is water permeable.

In some embodiments, the cross-linked polymer is a hydrophilic polymer characterized by a water contact angle of less than 90°, less than 80°, less than 70°, less than 60°, less than 50°, less than 40°, less than 30°, less than 20°, less than 15°, including any range between. As used herein, the term “water contact angle” of the cross-linked polymer refers to the physical property of a surface of the cross-linked polymer being in a form of a film or of a layer deposited on a substrate. The water contact angle of a surface can be determined according to well-known methods, some of them are disclosed in the Examples section hereinbelow.

In some embodiments, the cross-linked polymer is derived from a water soluble monomer. In some embodiments, the cross-linked polymer is derived from a monomer having a water solubility of at least 0.5 g/L, at least 1 g/L, at least 5 g/L, at least 10 g/L, at least 20 g/L, at least 30 g/L, at least 50 g/L, at least 70 g/L, at least 80 g/L, at least 100 g/L, between 1 and 100 g/L, between 10 and 100 g/L, between 10 and 80 g/L, between 10 and 60 g/L, between 20 and 100 g/L, between 20 and 90 g/L, between 20 and 200 g/L, between 10 and 200 g/L, including any range between.

In some embodiments, the cross-linked polymer comprises a hydrophilic thermoplastic polymer cross-linked via a cross-linking agent. In some embodiments, the cross-linked polymer is in a form of a hydrogel. In some embodiments, the hydrogel comprises a surface graft-polymerized polymer (e.g., a surface graft-polymerized hydrophilic thermoplastic polymer). In some embodiments, the cross-linked polymer is a hydrogel forming polymer. In some embodiments, the cross-linked polymer is a graft-polymerized hydrophilic thermoplastic polymer. In some embodiments, the cross-linked polymer is a graft-polymerized polyacrylate. In some embodiments, the hydrophilic thermoplastic polymer comprises an acrylate based polymer including any salt and any co-polymer thereof. In some embodiments, the hydrophilic thermoplastic polymer is substantially devoid of polyaminoacid, and/or of polydopamine. In some embodiments, the hydrophilic thermoplastic polymer is composed essentially of an acrylate based polymer including any salt and any co-polymer thereof.

In some embodiments, the term “hydrogel” as used herein refers to a non-Newtonian fluid (or a semi-solid) comprising a supramolecular structures of cross-linked polymer molecules (e.g., hydrophilic polymer such as polyacrylate or polymethacrylate) and water. In some embodiments, the supramolecular structures physically bind water molecules. In some embodiments, the supramolecular structures are in a form of a three-dimensional network of crosslinked polymeric chains.

In some embodiments, the hydrogel or the polymeric matrix disclosed herein is substantially devoid of fibers (e.g., CNT fiber, electrospun fibers, polymeric fibers, etc.). In some embodiments, the hydrogel or the polymeric matrix is characterized by a periodic structure. In some embodiments, the hydrogel or the polymeric matrix has an ordered structure, comprising the polymeric chains distributed therewithin in a form of a pattern (e.g. the entire hydrogel or the polymeric matrix is characterized by a defined periodic pattern of polymeric chains). In some embodiments, the pattern comprises a net. In some embodiments, the polymeric chains form a net within the hydrogel or the polymeric matrix. In some embodiments, the net is characterized by a (i) substantially homogenous pore size (e.g., an average distance between two neighboring polymeric chains; (ii) substantially homogenous pore density or distribution pattern within the hydrogel or the polymeric matrix, or both (i) and (ii).

In some embodiments, an acrylate based polymer comprises a polyacrylate, an ester thereof, an alkylated polyacrylate (e.g., polymethacrylate), a polyacrylamide, including any copolymer or any mixture thereof. Various acrylate polymers are known in the art. In some embodiments, the acrylate based polymer is or comprises a graft polymerized polymer. In some embodiments, the acrylate based polymer is or comprises in-situ graft polymerized polymer.

In some embodiments, the term “acrylate based polymer” as defined hereinbelow, refers to a non-crosslinked polymer. In some embodiments, an acrylate based polymer is represented by Formula 1:

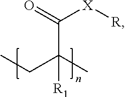

wherein n represents an integer; X represents O, OH, N, NH or NH₂, as allowed by valency; R1 and R each independently is absent or represents H or a substituent selected from alkyl (linear or branched), hydroxyalkyl, haloalkyl, aminoalkyl, cycloalkyl, glycol, polyethylenoxide, dimethyl aminoethyl, trimethyl aminoethyl, dimethyl aminoethyl-3-sulfopropyl, cyano, nitro, carboxy, hydroxy, halo, amino, or any combination thereof. In some embodiments, n represents an integer ranging between 2 and 100,000 including any range between.

In some embodiments, the acrylate based polymer is an uncharged polymer. In some embodiments, the acrylate based polymer is an ionizable polymer (e.g., capable of undergoing protonation or deprotonation in water, to result in a positively or a negatively charged polymer for example at a pH ranging between 5 and 8). In some embodiments, the acrylate based polymer is an intrinsically charged polymer (e.g., negatively charged and/or positively charged polymer). In some embodiments, the acrylate based polymer is a zwitterion.

In some embodiments, the acrylate based polymer is poly (2-(N-3-Sulfopropyl-N,N-dimethyl ammonium)ethyl methacrylate), including any salt or any co-polymer thereof.

In some embodiments, the cross-linked polymer is characterized by a cross-linking degree between 1 and 20%, between 1 and 10%, between 1 and 8%, between 1 and 7%, between 2 and 20%, between 2 and 10%, between 2 and 8%, between 1 and 6%, between 1 and 5%, between 1 and 4.5%, between 2 and 5%, between 1 and 2.5%, between 2.8 and 20%, between 2.8 and 10%, between 5 and 20%, between 5 and 10%, between 5.5 and 20%, between 5.5 and 10%, between 5.5 and 8%, including any range between. In some embodiments, the cross-linking degree is so as to obtain a mesh capable of retaining the particles within the coating and to enable water permeability of the coated substrate, as disclosed herein. Without being bound to any particular theory, it is postulated that a cross-linking degree of 10%, or of 20% or more significantly reduces water permeability of the coated substrate, thus making it less suitable for use as a membrane.

In some embodiments, the cross-linked polymer comprises a plurality of polymeric chains covalently bound to each other via a cross-linking agent. In some embodiments, the polymeric chains comprise a thermoplastic polymer chains (also used herein as “thermoplastic polymer”). In some embodiments, the cross-linked polymer is in a form of a polymeric matrix. In some embodiments, the polymeric matrix is an intertwined matrix composed of randomly distributed polymeric chains. In some embodiments, the polymeric chains are randomly distributed within the matrix. In some embodiments, the matrix is substantially devoid of aligned or oriented polymeric chains. In some embodiments, the matrix is substantially devoid of polymeric chains aligned or oriented in a specific direction. In some embodiments, the thermoplastic polymers composing the polymeric matrix are chemically identical polymers. In some embodiments, the polymeric matrix comprises a plurality of chemically distinct polymers. In some embodiments, the polymeric matrix comprises a mixture of chemically distinct polymeric species. In some embodiments, the polymeric matrix is in a form of a hydrogel comprising water molecules bound to the polymeric chains. In some embodiments, the polymeric matrix is water absorbing. In some embodiments, the polymeric matrix is swellable. In some embodiments, the coating described herein is capable of absorbing between 10 and 1000%, between 10 and 100%, between 50 and 1000%, between 100 and 1000%, between 10 and 500% of water, relative to the initial dry weight of the coated substrate of the invention, including any range between.

In some embodiments, a cross-linking agent is or comprises a bi-functional molecule (e.g., a bis-acrylate) capable of reacting with the monomer (and/or with the propagating polymeric chain) so as to covalently cross-link the polymeric chains. a skilled artisan will appreciate that upon cross-linking the cross-linking agent undergoes chemical modification. Accordingly, the cross-linked polymer comprises polymeric chains covalently bound via a chemically modified (or derivatized) cross-linking agent. A non-limiting example of a cross-linking agent is N′-methylenebisacrylamide.

In some embodiments, the polymeric chains are in contact with the particles described herein, thereby forming the coating. In some embodiments, the coating is in a form of a layer. In some embodiments, the coating is in a form of a single layer or of a plurality of distinct layers. In some embodiments, one or more layers of the coating independently comprise the cross-linked polymer and the particles described herein. In some embodiments, one or more layers of the coating is in a form of a composite material.

In some embodiments, the particles are embedded within the polymeric matrix. In some embodiments, particles are homogenously distributed within the polymeric matrix. In some embodiments, the particles are enclosed by the polymeric matrix. In some embodiments, the particles are physisorbed and/or chemisorbed on or within the polymeric matrix.

In some embodiments, the particles are in a form of a first layer and the polymeric matrix is in a form of a second layer. In some embodiments, the first layer is on top and bound to the substrate. In some embodiments, the first layer and/or the coating substantially covers at least one surface of the substrate. In some embodiments, substantially covers comprises at least 80%, at least 90%, at least 95%, at least 97%, at least 99%, at least 99.9% surface coverage of the substrate, including any range between.

In some embodiments, the second layer is on top and bound to the first layer. In some embodiments, the second layer is in a form of a coating on top of the first layer. In some embodiments, the second layer reinforces the first layer. In some embodiments, the second layer stabilizes the first layer. In some embodiments, the second layer prevents disintegration of the first layer. In some embodiments, the second layer prevents detachment of the first layer from the substrate. In some embodiments, the second layer stabilizes the first layer. In some embodiments, the second layer (or the cross-linked polymer) provides physical stability to the particles sufficient for use of the coated substrate as a filtration membrane (e.g., water filtration membrane or UF membrane). In some embodiments, the second layer (or the cross-linked polymer) provides physical stability to the coated substrate (e.g., by substantially preventing disintegration of the coating and/or leakage of the particles therefrom), wherein the physical stability is sufficient for implementation of the coated substrate as a membrane. In some embodiments, the physical stability is sufficient to support a water flux ranging between 10 and 1000 L·m⁻²·h⁻¹·bar⁻¹, between 100 and 1000 L·m⁻²h⁻¹·bar⁻¹, between 100 and 2000 L·m⁻²·h⁻¹·bar⁻¹, including any range between. In some embodiments, the coating and the substrate are water permeable. In some embodiments, the coated substrate is configured to support a water flux ranging between 10 and 1000 L·m⁻²·h⁻¹·bar⁻¹, between 100 and 1000 L·m⁻²·h⁻¹·bar⁻¹, between 100 and 2000 L·m⁻²·h⁻¹·bar⁻¹, including any range between.

In some embodiments, the cross-linked polymer (or the second layer) provides barrier properties to the coated substrate, thereby substantially increasing stability thereof. In some embodiments, the cross-linked polymer (or the second layer) provides barrier properties so as to substantially maintain coating integrity. In some embodiments, the cross-linked polymer (or the second layer) provides barrier properties so as to substantially prevent leakage of the particles therefrom. In some embodiments, a stable coated substrate is substantially devoid of coating disintegration and/or substantially maintains the initial content of the particles within the coating. In some embodiments, the cross-linked polymer (or the second layer) substantially maintains the initial content of the particles within the coating. In some embodiments, the physical stability is sufficient to maintain at least 80%, at least 90%, at least 95%, at least 97%, at least 99% of the initial content of the particles within the coating upon successive (e.g. at least 2, at least 3, at least 5 at least 10, at least 20, at least 50, at least 100) filtration cycles. Coating integrity can be assessed by determining the concentration of the particles' constituents within the filtrate (for example, in the case MOF particles are implemented, significantly enhanced concentration of metal cations within the filtrate is indicative of coating instability).

In some embodiments, the term “bound” refers to any non-covalent bond or interaction, such as electrostatic bond, dipole-dipole interaction, Van-der-walls' interaction, ionotropic interaction, hydrogen bond, hydrophobic interactions, pi-pi stacking, London forces, etc. In some embodiments, the non-covalent bond or interaction is a stable bond or interaction, wherein stable is as described herein.

In some embodiments, the cross-linked polymer is in a form of a mesh (e.g., 2D or 3D mesh structure). In some embodiments, the mesh is porous, wherein an average pore size of the mesh is the same or less than the average size of the particles disclosed herein. In some embodiments, the average pore size of the mesh is less than the average size of the particles by at least 10%, at least 100%, at least 500%, at least 1000%, at least 10,000%, including any range between. In some embodiments, the average pore size of the mesh is between 1 nm and 1 μm, between 1 and 100 nm, between 5 and 100 nm, between 10 and 100 nm, between 1 and 500 nm, between 10 and 500 nm, between 100 and 1000 nm, including any range between.

In some embodiments, the term “porous” as used herein refers to a material characterized by porosity, e.g., comprises pores, holes, voids, or space, within its network. However, porous layers may optionally comprise an additional substance in the spaces between the polymeric chains, provided that at least a portion of the volume of the voids is not filled in by the additional substance. In some embodiments, the additional substance comprises particles disclosed herein.

In some embodiments, the porosity is measured as a fraction, between 0 to 1, relative to the volume of the coating which consists of voids (or pores).

In some embodiment, porosity of the coating is between 0.1 to 0.99.

In some embodiment, porosity of the coating is 0.1, 0.2, 0.3, 0.4, 0.5, 0.6, 0.7, 0.8, 0.9, or 0.99, including any value and range therebetween.

In some embodiments, the coating is water permeable. In some embodiments, the porosity of the coating is sufficient to provide water permeability to the coating. In some embodiments, the porosity of the coating is sufficient to support water flux at a flux disclosed herein.

The term “porosity” refers to a measure of the void spaces in the material and, in some embodiments, defined as the fraction of the free volume or pore volume of a material relative to the total volume of the material, determined by well-known physical measurements, such as N₂ adsorption/desorption.

In some embodiments, the coating and/or the coated substrate of the invention is a composite material. In some embodiments, the coating is a solid coating. In some embodiments, the coating and/or the coated substrate of the invention is in a form of a layered composite. As used herein, “composite material” is a material produced from two or more constituent materials with notably dissimilar chemical or physical properties that, when merged, create a material with properties, unlike the individual elements.

In some embodiments, a composite is referred to a substantially uniform material which cannot be easily separated into individual constituents (e.g., the particles, and the cross-linked polymer of the invention). In some embodiments, a composite is substantially devoid of phase separation or disintegration (also referred to herein as “stable” composite). In some embodiments, a composite is substantially devoid of a multi-layered structure. In some embodiments, the coating is a single layer coating.

In some embodiments, the term “layer”, refers to a substantially uniform thickness of a material. In some embodiments, the layer or film comprises a single layer, or a plurality of layers. In some embodiments, the term layer and the term film are used herein interchangeably.

In some embodiments, the coating is in a form of a distinct layer bound to the substrate. In some embodiments, the particles and/or the cross-linked polymer is/are bound to the substrate. In some embodiments, the particles are bound to the substrate via electrostatic interactions and/or via coordinative bonds.

In some embodiments, the coating has a thickness between 0.05 μm and 100 μm, between 0.1 μm and 100 μm, between 0.1 μm and 10 μm, between 0.05 μm and 10 μm, between 0.5 μm and 100 μm, between 0.5 μm and 50 μm, between 1 μm and 50 μm, between 1 μm and 100 μm, between 1 μm and 100 μm, between 1 μm and 10 μm, between 10 μm and 1000 μm, between 100 μm and 1000 μm, including any range between. In some embodiments, the coating thickness refers to a dry thickness. In some embodiments, the coating is in a form of a layer characterized by a substantially uniform thickness. In some embodiments, the term “thickness” refers to the median value of the shortest distance from one side of the coating layer to another side of the coating layer (e.g., from the inner surface to the outer surface of the coating). Typically, the thickness is measured in an orthogonal direction.

In some embodiments, the coating comprises an inner surface facing the substrate and an outer surface facing the ambient. In some embodiments, the outer surface of the coating is substantially composed of the cross-linked polymer. In some embodiments, the inner surface of the coating is substantially composed of the particles disclosed herein. In some embodiments, the outer surface of the coating is characterized by any of (i) a negative zeta potential; (ii) surface roughness of between 10 and 40 nm, or both (i) and (ii). In some embodiments, the outer surface of the coating is further characterized by a water contact angle of less than 90°, less than 80°, less than 70°, less than 60°, less than 50°, less than 40°, less than 30°, less than 20°, less than 15°, including any range between. In some embodiments, the outer surface of the coating is further characterized by a water contact angle between about 5° and about 50°, about 5° and about 60°, about 5° and about 10°, about 100 and about 50°, about 100 and about 40°, about 5° and about 30°, about 5° and about 40°, about 100 and about 30°, about 300 and about 60°, including any range between. As used herein, “water contact angle” describes the angle that water forms with respect to the outer surface of the coating at the place where the free surface of quiescent liquid contacts to the horizontal surface of the coating.

Typically, but not exclusively, in order to measure the contact angle, a drop of water is formed on the tip of a hypodermic needle attached to a screw syringe. The syringe is fastened to a stand which reduces any irregularities that are produced by manual drop deposition. The substrate is then raised until it touches the drop using the Y control of the stage. The drop is then brought into the field of view and onto the focal point of the microscope by x-y translation of the stage and image is captured. The contact angle is calculated by methods known in the art.

In some embodiments, the outer surface of the coating is characterized by a negative zeta potential in a range between −1 and −60, between −1 and −20, between −5 and −30, between −5 and −20, between −5 and −10, between −10 and −30, between −10 and −60, between −1 and −40, between −1 and −50, between −5 and −50, between −5 and −60, between −5 and −40, between −1 and −20, between −20 and −30 mV, including any range between (e.g., when measured at a pH ranging between 4 and 9). In some embodiments, the outer surface of the coating is characterized by a greater negative zeta potential compared to the pristine (uncoated) substrate, wherein greater is by at least 1 mV, at least 5 mV, at least 10 mV greater negative zeta potential, including any range between.

In some embodiments, the outer surface of the coating is characterized by a surface roughness between 10 and 40 nm, between 10 and 100 nm, between 1 and 40 nm, between 1 and 100 nm, between 10 and 30 nm, between 10 and 20 nm, between 20 and 100 nm, including any range between.

The term “roughness” as used herein relates to the irregularities in the surface texture. Irregularities are the peaks and valleys of a surface.

In some embodiments, roughness value is computed by AA (arithmetic average) and RMS (root-mean-square). The AA method uses the absolute values of the deviations in the averaging procedure, whereas the RMS method utilizes the squared values of the deviations in the averaging process.

In some embodiments, the coating disclosed herein is composed essentially of the cross-liked polymer and the particles, disclosed herein.

In some embodiments, a weight per weight (w/w) ratio between the particles and the cross-linked polymer within the coating is between 1:10 and 1:10,000, between 1:10 and 10:1, between 1:10 and 1:1000, between 1:10 and 1:100, between 1:1 and 1:100, between 1:10 and 1:50, between 1:50 and 1:1000, between 1:50 and 1:10,000, between 1:100 and 1:1000, between 1:100 and 1:10,000, between 100:1 and 1:1, between 50:1 and 1:1, between 10:1 and 1:1, between 80:1 and 1:1, between 80:1 and 10:1, between 100:1 and 10:1, between 100:1 and 20:1, between 100:1 and 50:1, between 50:1 and 30:1, between 30:1 and 10:1, between 10:1 and 5:1, between 5:1 and 1:1, including any range between.

In some embodiments, a w/w concentration of the particles within the coated substrate is between 0.001 and 30%, between 0.01 and 30%, between 0.1 and 30%, between 0.1 and 20%, between 0.1 and 10%, between 0.1 and 5%, between 1 and 30%, between 1 and 20%, between 5 and 30%, between 5 and 20% between 1 and 5%, between 0.5 and 10%, between 0.5 and 20%, between 0.01 and 1%, between 1 and 10%, including any range between.

In some embodiments, the particles are porous crystalline particles. In some embodiments, the particles are crystalline framework structures (CFS). In some embodiments, the particles are nanoparticles. In some embodiments, the particles are nanoparticular CFS. In some embodiments, the particles are sorbents (e.g., nanoparticular sorbents). In some embodiments, the particles are characterized by a porosity sufficient for absorbing water pollutants (e.g., inorganic salts such as nitrate anions, hydrophobic materials such as hydrocarbons, organic solvents, oil, etc.). In some embodiments, the particles or CFS comprise metal-organic frameworks (MOF), covalent organic frameworks (COF), or any combination thereof. In some embodiments, the CFS are substantially crystalline. In some embodiments, the CFS are substantially devoid of amorphous particles, or amorphous matter. In some embodiments, the CFS are substantially crystalline. In some embodiments, the CFS comprise a metal in a crystalline state. In some embodiments, at least 50%, at least 60%, at least 70%, at least 80%, at least 90%, at least 95%, at least 99%, at least 99.5% by weight (or atomic percentage) of the metal within the CFS is in a crystalline state. In some embodiments, In some embodiments, at least 50%, at least 60%, at least 70%, at least 80%, at least 90%, at least 95%, at least 99%, at least 99.5% by weight (or atomic percentage) of the metal within the coated substrate of the invention is in a crystalline state. In some embodiments, at least 50%, at least 60%, at least 70%, at least 80%, at least 90%, at least 95%, at least 99%, at least 99.5% by weight of the CFS within the coated substrate of the invention is in a crystalline state. In some embodiments, the presence of the particles within the coated substrate (and or the crystallinity degree) can be determined by XRD, FT-IR. Exemplary XRD/FT-IR spectra of the coated substrates are presented herein.

Exemplary particles include but are not limited to COF-102, COF-103, COF-105, COF-108 and COF-300 particles, zeolitic imidazole framework (ZIF) particles, such as ZIF-L, ZIF-8, ZIF-67 or any combination thereof. Other porous crystalline particles (such as CFS, or any additional organic, inorganic or metal-organic porous crystalline particles) are well known in the art.

In some embodiments, the particles are characterized by an average particle size between 1 nm and 20 μm, between 1 nm and 10 μm, between 1 nm and 1 μm, between 1 nm and 5 μm, between 10 nm and 20 μm, between 10 nm and 10 μm, between 10 nm and 1 μm, between 10 nm and 5 μm, between 1 nm and 100 nm, between 1 nm and 1000 nm, between 1 nm and 500 nm, between 10 nm and 500 nm, between 500 nm and 20 μm, between 500 nm and 10 μm, between 500 nm and 5 μm, between 500 nm and 3 μm, including any range between.

In some embodiments, the particles are bound to the substrate to obtain a dense layer (e.g. the first layer). In some embodiments, the first layer is characterized by a thickness between 100 nm and 10 μm, between 500 nm and 10 μm, between 700 nm and 10 μm, between 1 and 10 μm, between 1 and 5 μm, between 500 nm and 5 μm, between 100 nm and 5 μm, between 100 nm and 1 μm, between 500 nm and 3 μm, including any range between.

In some embodiments, the particles are stably bound to the substrate, thus forming the coated substrate of the invention characterized by sufficient stability as described herein. In some embodiments, the particles are in-situ grown particles. In some embodiments, the particles are attached to the substrate via electrostatic bonds, non-covalent bonds and/or coordinative bonds.

In some embodiments, the particles are stably bound to a chemically modified substrate. In some embodiments, the substrate is a porous substrate. In some embodiments, the outer surface of the substrate is chemically modified. In some embodiments, chemical modification comprises a plurality of surface groups comprising carboxy, amino, amide, hydroxy, or any combination thereof. In some embodiments, the chemical modification comprises an ionizable group, wherein ionizable is as described herein. In some embodiments, the chemical modification provides a negative surface charge to the substrate. In some embodiments, the chemically modified substrate is characterized by a greater negative zeta potential compared to the pristine substrate, wherein greater is by at least 1 mV, at least 5 mV, at least 10 mV, at least 20 mV, at least 30 mV greater negative zeta potential, including any range between.

In some embodiments, the chemically modified substrate is characterized by isoelectric point at a pH value between 3.5 and 5.5, or about 4.

In some embodiments, the chemical modification provides a binding affinity to the outer surface of the substrate, wherein the binding affinity is sufficient to facilitate attachment of the particles thereto. In some embodiments, the chemically modified substrate is characterized by a significantly enhanced binding affinity to the particles, compared to a pristine substrate. In some embodiments, binding affinity of the chemically modified substrate is enhanced by at least 2, 10, 100, 1000, or 10000 times, relative to the pristine substrate.

In some embodiments, the substrate is composed essentially of a thermoplastic polymer. In some embodiments, the substrate comprises a hydrophobic polymer. In some embodiments the thermoplastic polymer is a hydrophobic polymer (e.g. characterized by a water contact angle of above 90°, or between 90 and 160°). In some embodiments the thermoplastic polymer is a hydrophilic polymer (e.g. characterized by a water contact angle of below 90°, or between 1 and 90°). In some embodiments the thermoplastic polymer is selected from a fluorinated polymer such as polyvinylidene fluoride, a polysulfone, a polyol, a polyether sulfone, a polyamide, a polyester, cellulose acetate, nitrocellulose, polybenzimidazole, PVP, polymer of intrinsic microporosity, a polyolefin, including any copolymer and any mixture thereof. In some embodiments, the polyolefin comprises a polyethylene, a polypropylene, polymethylpentene (PMP), polybutene-1 (PB-1); ethylene-octene copolymer, stereo-block polypropylene, propylene-butane copolymer, low-density polyethylene (LDPE), linear low-density polyethylene (LLDPE), very-low-density polyethylene (VLDPE), ultra-low-density polyethylene (ULDPE), medium-density polyethylene (MDPE), high-density polyethylene (HDPE) including any copolymer and any mixture thereof.

In some embodiments, the polyol comprises polyvinyl alcohol (PVA), ethylene vinyl alcohol copolymer (EVOH), or both.

Exemplary polymers of intrinsic microporosity are well-known in the art containing but are not limited to: PIM-1, PIM-EA-TB, PIM-PY, PIM-EA-TB-H₂, and PIM-7 or any combination thereof.

In some embodiments, polymers of intrinsic microporosity characterized by a pore size range between about 1 nm and about 10 nm, and/or by a surface area between about 700 and 1000 m² g⁻¹ including any range between.

In some embodiments, the surface modified substrate is characterized by a water contact angle of less than 90°, less than 80°, less than 70°, less than 60°, less than 50°, less than 40°, less than 30°, less than 20°, less than 15°, between 10 and 90°, between 10 and 70°, between 5 and 70°, between 10 and 60°, between 15 and 60°, between 20 and 60°, between 20 and 70°, between 30 and 70°, between 15 and 40°, between 15 and 50°, between 15 and 30°, including any range between.

In some embodiments, the surface modified substrate is characterized by at least 5°, at least 10°, at least 20°, at least 30°, lower water contact angle, compared to a pristine substrate. In some embodiments, the pristine substrate comprises the same thermoplastic polymer, and wherein the outer surface of the pristine substrate is unmodified. In some embodiments, the pristine substrate is an unmodified substrate composed essentially of unmodified (or pristine) thermoplastic polymer.

In some embodiments, the substrate comprises a hydrophilic thermoplastic polymer selected from polyacrylonitrile, polyether sulfone, nitrocellulose, including any copolymer or any mixture thereof. In some embodiments, the term “hydrophilic” and the term “water wettable” are used herein interchangeably. Additional hydrophilic (and/or water wettable) polymers are well-known in the art. In some embodiments, the hydrophilic thermoplastic polymer characterized by a water contact angle of less than 90°, less than 80°, less than 70°, less than 60°, less than 50°, less than 40°, less than 30°, less than 20°, including any range between.

In some embodiments, the substrate is a porous substrate. In some embodiments, the substrate comprises a plurality of pores characterized by a pore size 2 and 100 nm, between 10 and 100 nm, between 5 and 100 nm, between 20 and 100 nm, between 30 and 100 nm, between 2 and 50 nm, between 50 and 100 nm, between 5 and 80 nm, including any range between. In some embodiments, the substrate comprises a plurality of pores characterized by an average pore size between 5 nm to 300 nm, e.g., 5 nm, 10 nm, 20 nm, 30 nm, 40 nm, 50 nm, 60 nm, 70 nm, 80 nm, 90 nm, 100 nm, 150 nm, 200 nm, 250 nm, 300 nm, 350 nm, 400 nm, 450 nm, or 500 nm, including any value or range therebetween.

In some embodiments, porosity of the substrate is 0.1, 0.2, 0.3, 0.4, 0.5, 0.6, 0.7, 0.8, 0.9, or 0.99, including any value and range there between. In some embodiment, the porous substrate is in a form of a membrane (e.g., filtration membrane, or ultrafiltration membrane) configured to support a water flux as described herein.

In some embodiments, the disclosed coated substrate is characterized by a density in the range of from 0.05 g/cm³ to 2 g/cm³. In some embodiments, the disclosed coated substrate is characterized by a density in the range of from 0.1 g/cm³ to 1 g/cm³. In some embodiments, the disclosed coated substrate is characterized by a density in the range of from 0.2 g/cm³ to 0.8 g/cm³.

In some embodiments, the disclosed coated substrate is characterized by a density of 0.05 g/cm³, 0.1 g/cm³, 0.2 g/cm³, 0.3 g/cm³, 0.4 g/cm³, 0.5 g/cm³, 0.6 g/cm³, 0.7 g/cm³, 0.8 g/cm³, 0.9 g/cm³, 1 g/cm³, 1.1 g/cm³, 1.2 g/cm³, 1.3 g/cm³, 1.4 g/cm³, 1.5 g/cm³, 1.6 g/cm³, 1.7 g/cm³, 1.8 g/cm³, 1.9 g/cm³, or 2 g/cm³, including any value and range therebetween.

In some embodiments, the disclosed coated substrate is characterized by substantially the same mechanical strength, thermal stability, and or water permeability as the pristine substrate. In some embodiments, the water permeability of the coated substrate is reduced in a range between 10 and 70%, between 10 and 50%, between 10 and 30%, between 10 and 20%, relative to the pristine substrate including any value and range therebetween.

The term “mechanical strength” as used herein means overall and desirable strength such as breaking strength, rigidity, flexibility and/or toughness.

In some embodiments, the thermal stability of the coated substrate is predetermined by the melting point of the substrate and of the cross-linked polymer. In some embodiments, the coated substrate exhibits thermal stability up to e.g., at least about 100° C., at least about 150° C., up to about 200° C., up to about 300° C., or up to about 400° C. including any value and range therebetween.

### Membrane

In another aspect, there is provided an article comprising the coated substrate disclosed herein. Exemplary articles include, but are not limited to, agricultural device, containers, agricultural devices, construction elements, water treatment devices and elements thereof, organic waste treatment devices and elements thereof, microelectronic devices, microelectromechanical devices, photovoltaic devices, or microfluidic devices.

In some embodiments, the article is a filtration membrane.

In some embodiments, the article is a water filtration membrane as defined herein throughout, for the selective separation of chemical species (e.g., nitrates, and/or organic lipophilic molecules such as organic solvents, oil, hydrocarbons, etc.), in particular for the selective purification of contaminated water (e.g., produced water).

As demonstrated in the Examples section below, the filtration membrane exhibits improved oil rejection and flux recovery, compared to a pristine membrane. Furthermore, the exemplary membrane of the invention is substantially devoid of biofouling upon prolonged operation.

In some embodiments, the disclosed membrane is devoid of an additional polymeric layer (such as supporting substrate or polymer on top of the outer surface of the coating).

In some embodiments, the membrane may withstand some level of applied pressure or force as described below.

In some embodiments, the term “filtration membrane” as used herein throughout refers to a membrane characterized by their molecular weight cut-off and/or their retention values for inorganic salts and/or small organic molecules.

In some embodiments, the molecular weight cut-off of the membrane is about 2 kDa, about 10 kDa, about 50 kDa, about 100 kDa, about 150 kDa, about 160 kDa, about 170 kDa, about 180 kDa, about 190 kDa, about 200 kDa, about 250 kDa, about 300 kDa about 340 kDa, about 350 kDa, about 400 kDa, between about 2 and about 300 kDa, between about 2 and about 200 kDa, including any range between.

In some embodiments, the disclosed membrane is a microfiltration or ultrafiltration or nanofiltration membrane. As further demonstrated in the Examples section below, the unique morphology and composition of the disclosed membrane (e.g., the coated substrate of the invention) may facilitate high permeation rates of the membrane. Specifically, the inventors successfully implemented the above disclosed coating on the ultrafiltration membrane, as exemplified in the Examples section. Accordingly, it is postulated that the disclosed coating may be suitable for application on a polymeric ultrafiltration membrane, and further on a nanofiltration membrane and optionally on a microfiltration membrane.

In some embodiments, by “high permeation rate” it is meant to refer to permeation rate of at least about 10 to at least about 600 L/m²h per bar applied, or between about 10 to about 600 L/m²h per bar applied, or between about 30 to about 600 L/m²h per bar applied, for example, at least about 10 L/m²h per bar applied, at least about 30 L/m²h per bar applied, at least about 60 L/m²h per bar applied, at least about 100 L/m²h per bar applied, at least about 150 L/m²h per bar applied, at least about 200 L/m²h per bar applied, at least about 250 L/m²h per bar applied, at least about 300 L/m²h per bar applied, at least about 350 L/m²h per bar applied, at least about 400 L/m²h per bar applied, at least about 450 L/m²h per bar applied, at least about 500 L/m²h per bar applied, at least about 448 L/m²h per bar applied, including any range between.

In some embodiments, the disclosed membrane is characterized by substantially the same or increased water permeability, compared to a pristine membrane (e.g. a similar membrane without the coating). In some embodiments, the disclosed membrane is characterized by increased water permeability, compared to a pristine membrane, wherein increased is by about 5%, about 10%, about 13%, about 15%, about 20%, about 30%, about 40%, about 50%, including any range between.

In some embodiments, the disclosed membrane is a water filtration membrane characterized by a thickness of between 50 and 1000 μm, between 50 and 200 μm, between 200 and 500 μm, between 200 and 1000 μm, between 10 and 1000 μm, between 10 and 100 μm, between 1 and 1000 μm, between 1 and 100 μm, between 10 and 500 μm, between 100 and 1000 μm, between 100 and 500 μm, between 500 and 1000 μm, including any range between.

In some embodiments, the disclosed membrane is an ultrafiltration membrane, characterized by a pore size between 2 and 100 nm, between 10 and 100 nm, between 5 and 100 nm, between 20 and 100 nm, between 30 and 100 nm, between 2 and 50 nm, between 50 and 100 nm, between 5 and 80 nm, including any range between.

In some embodiments, the disclosed membrane is characterized by flux recovery ratio of at least 70%, at least 75%, at least 80%, at least 85%, at least 90%, at least 95%, at least 97%, at least 98%, at least 98.5%, at least 99%, between 70 and 95%, between 70 and 99%, between 70 and 98.5%, including any range between.

In some embodiments, the disclosed membrane is characterized by at least 50%, at least 60%, at least 70%, at least 75%, at least 80%, at least 90%, at least 93%, at least 95%, at least 96%, at least 97%, at least 99%, at least 98%, at least 99.5%, at least 99.7%, at least 99.9%, at least 99.99% oil rejection, including any range between.

In some embodiments, the disclosed membrane is stable (e.g. substantially retains the initial particle content, substantially devoid of disintegration, separation of the coating form the substrate, fouling, substantially maintains any of: dimensions, porosity, water permeability, physical properties such as elasticity, selectivity, oil rejection) upon exposure thereof to any one of: successive water treatment cycles (e.g. 2, 3, 5, 7, 10, 20, 50, 100, between 2 and 100, between 2 and 10, between 2 and 20, between 2 and 50, including any range between); temperature of at most 300° C., at most 200° C., at most 150° C., at most 100° C., or between −30 and 200° C., between 0 and 200° C., between −30 and 300° C., between −30 and 150° C., between 0 and 300° C., including any range or value therebetween. In some embodiments, the term “stable” refers to the capability of the membrane to maintain its structural, physico-mechanical, and/or chemical integrity. In some embodiments, the membrane is referred to as stable, if it is substantially devoid of decomposition and/or dissociation wherein substantially is as described herein.

While studying the activity of the disclosed membrane as described herein, the present inventors have surprisingly uncovered that membrane exhibits high antifouling activity and can therefore be beneficially incorporated in filtration systems in which such an activity is desired.

Herein “anti-biofouling activity” or “antifouling activity” is referred to as an ability to inhibit (prevent), reduce or retard biofilm formation or microbial attachment to the outer surface of the coated substrate (e.g., membrane disclosed herein).

The term “biofilm”, as used herein, refers to an aggregate of living cells which are stuck to each other and/or immobilized onto a surface as colonies. The cells are frequently embedded within a self-secreted matrix of extracellular polymeric substance (EPS), also referred to as “slime”, which is a polymeric sticky mixture of nucleic acids, proteins and polysaccharides.

In the context of the present embodiments, the living cells forming a biofilm can be cells of a unicellular microorganism (prokaryotes, archaea, bacteria, eukaryotes, protists, fungi, algae, euglena, protozoan, dinoflagellates, apicomplexa, trypanosomes, amoebae and the likes), or cells of multicellular organisms in which case the biofilm can be regarded as a colony of cells (like in the case of the unicellular organisms) or as a lower form of a tissue.

In the context of the present embodiments, the cells are of microorganism origins, and the biofilm is a biofilm of microorganisms, such as bacteria and fungi. The cells of a microorganism growing in a biofilm are physiologically distinct from cells in the “planktonic form” of the same organism, which by contrast, are single cells that may float or swim in a liquid medium. Biofilms can go through several life-cycle steps which include initial attachment, irreversible attachment, one or more maturation stages, and dispersion. The phrase “anti-biofilm formation activity” refers to the capacity of a substance to affect the prevention of formation of a biofilm of bacterial, fungal and/or other cells, and/or to affect a reduction in the rate of buildup of a biofilm of bacterial, fungal and/or other cells, on the outer surface of the membrane.

In some embodiments, the biofilm comprises bacterial cells. In some embodiments, the bacterial cells are of bacteria selected from the group consisting of: all Gram-positive and Gram-negative bacteria.

In some embodiments, the Gram-negative biofilm-forming bacteria may be selected from the group of species such as, but not limited to, Proteus, Enterobacter, Citrobacter, Shigella, Escherichia, Edwardsiella, Aeromonas, Plesiomonas, Moraxella, Alcaligenes, and Pseudomonas.

As demonstrated hereinbelow, a membrane as described herein was shown to exhibit antibiofilm activity and can thus prevent, retard or reduce the formation or the mass of a biofilm. Therefore, the membrane as described herein can be efficiently incorporated within filtration systems containing same in which anti-biofilm formation activity is beneficial (e.g., is required or desired).

As used herein, the term “preventing” in the context of the formation of a biofilm, indicates that the formation of a biofilm is essentially nullified or is reduced by at least 20%, at least 30%, at least 40%, at least 50%, at least 60%, at least 70%, at least 80%, or at least 90%, including any value and range therebetween, of the appearance of the biofilm compared to a pristine membrane.

Alternatively, preventing means a reduction to at least e.g., 99.9%, 95%, 93%, 90%, 80%, 70%, 60% 30%, 15%, 10%, or 5% of the appearance of the biofilm compared to a pristine membrane. Methods for determining a level of appearance of a biofilm are known in the art.

In some embodiments, an amount of biofilm formed on the disclosed article (e.g., filtration membrane) or a filtration system containing same with bacterial cells in the presence of a growth medium for 24 hours is lower than 10⁵ CFU. In some embodiments, it is lower than 10⁴ CFU, lower than 10³ CFU, lower than 10² CFU or even lower. In some embodiments, the membrane of the invention exposed to successive filtration cycles is characterized by a microbial loading of at most 10⁵ CFU, at most 10⁴ CFU, at most 10³ CFU, at most 10² CFU, at most 10 CFU per square centimeter of the membrane's surface, or even lower.

As described herein throughout, such articles of manufacturing include, but are not limited to, processing devices, medical devices, packages and containers, agricultural devices, construction elements, water treatment systems and elements thereof, and organic waste treatment systems and elements thereof.

According to some embodiments of the present invention, the composition presented herein is packaged in a packaging material and identified in print, in or on the packaging material, for use in reducing or preventing the formation of a biofilm and/or disrupting a biofilm in or on a substrate.

In some embodiments, the disclosed membrane is sterilized and used for aseptic applications.

Alternatively, the disclosed membrane can be incorporated within any of the articles of manufacturing described herein, during manufacture of the article of manufacturing.

In one embodiment of the invention, there is provided a method for reducing the concentration of a contaminant in a fluid (e.g., contaminated water, PW, a water effluent, etc.), comprising the step of contacting the fluid with the disclosed article (e.g., filtration membrane). In some embodiments, contacting comprises performing a filtration (e.g. in a continuous mode by circulation of the contaminated water through the article; or in a batch mode). In some embodiments, contacting step is further repeated one or more times.

According to another aspect of the present invention there is provided a method for treating a contaminated water, comprising contacting the contaminated water with the membrane of the invention under appropriate conditions, thereby reducing a concentration of one or more pollutant within the contaminated water. In some embodiments, the method for treating a contaminated water thereby obtaining a treated water. In some embodiments, the terms “treated water” and “reclaimed water” are used herein interchangeably.

In some embodiments, the reclaimed water refers to water suitable for recycling. It should be apparent that the term “reclaimed water” encompasses water which at least meets the regulatory standards in any specific jurisdiction, so that the reclaimed water may be recycled or disposed into a reservoir or into a natural water source such as lake, pond, sea, ocean, etc. Especially, the regulatory standards prescribe a maximum amount of common pollutants (such as, metals, heavy metals, nitrogen species, phosphorus species, etc.). Specifically, the term “reclaimed water” may encompass water having different thresholds of pollutants such as phosphorus specie.

In some embodiments, the contaminated water, as used herein, comprises wastewater from dairy industry, olive oil mill, wineries, piggeries, cowsheds, slaughterhouses, fruit and vegetable processing industry, or soy or coffee bean industry or a combination thereof. In some embodiments, the wastewater is a recreational water from a coastal beach, lake, river, or pond. In some embodiments, the wastewater comprises dairy wastewater.

In some embodiments, the contaminated water comprises a drinking water or a source thereof, wherein the drinking water or a source thereof is from a river, a lake, a reservoir, a pond, a stream, groundwater, spring water, surface water, and/or seawater or combinations thereof.

In some embodiments, the method is for reducing contaminant concentration within the contaminated water. In some embodiments, reducing comprises eliminating at least 50%, at least 60%, at least 70%, at least 75%, at least 80%, at least 90%, at least 93%, at least 95%, at least 96%, at least 97%, at least 99%, at least 98%, at least 99.5%, at least 99.7%, at least 99.9%, at least 99.99%, of the initial contaminant concentration within the contaminated water, including any range therebetween. In some embodiments, reducing comprises eliminating between 70 and 99.7%, between 80 and 99.7%, between 90 and 99.7%, between 95 and 99.7%, between 70 and 99.99% of the initial contaminant concentration within the contaminated water, including any range therebetween. In some embodiments, reducing comprises complete elimination of the contaminant from the contaminated water (e.g., to obtain treated water with a contaminant concentration below the detection limit thereof).

The disclosed method is effective for treating one or more contaminant components, e.g., inorganic water contaminants (e.g., phosphorous species such as phosphate, diphosphate, polyphosphate, etc., nitrogen species such as nitrate, nitrogen oxides, nitrite), organic-based components, such as hydrocarbons, and/or organic-based components. Examples of organic-based and hydrocarbon-based contaminant components which may be processed in accordance with the present invention include, but are not limited to, petroleum (crude oils including topped crude oils), organic acids such as benzoic acid, ketones, aldehydes, aromatic components including phenols and the like, organic materials containing hetero atoms such as nitrogen, sulfur and halogen, e.g., chloride, and the like, dyes, polymeric materials, including, without limitation carbohydrate (e.g., polysaccharides), proteins, fatty acids and mixtures thereof. Other contaminants which may be treated in the present process include, for example, and without limitation, materials which are active components in or products of a manufacturing process, such as cyanide or hydrazine, or a process by-product, organic insecticides, herbicides, sewage contamination, and pesticides resulting from soil leaching due to continuous water usage in agriculture, e.g., the production of fruits and vegetables particularly in arid to semi-arid climates.

### Definitions

As used herein, the term “alkyl” describes an aliphatic hydrocarbon including straight chain and branched chain groups. In some embodiments, the alkyl group has 1 to 20 carbon atoms, between 1 and 10, between 1 and 5, between 5 and 10, between 10 and 15, between 15 and 20, including any range between.

In some embodiments, the alkyl group has 21 to 100 carbon atoms, and more preferably 21-50 carbon atoms. Whenever a numerical range e.g., “21-100”, is stated herein, it implies that the group, in this case the alkyl group, may contain 21 carbon atoms, 22 carbon atoms, 23 carbon atoms, etc., up to and including 100 carbon atoms. In the context of the present invention, a “long alkyl” is an alkyl having at least 20 carbon atoms in its main chain (the longest path of continuous covalently attached atoms). A short alkyl therefore has 20 or less main-chain carbons. The alkyl can be substituted or unsubstituted, as defined herein.

The term “alkyl”, as used herein, also encompasses saturated or unsaturated hydrocarbon, hence this term further encompasses alkenyl and alkynyl.

The term “alkenyl” describes an unsaturated alkyl, as defined herein, having at least two carbon atoms and at least one carbon-carbon double bond. The alkenyl may be substituted or unsubstituted by one or more substituents, as described hereinabove.

The term “alkynyl”, as defined herein, is an unsaturated alkyl having at least two carbon atoms and at least one carbon-carbon triple bond. The alkynyl may be substituted or unsubstituted by one or more substituents, as described hereinabove.

The term “cycloalkyl” describes an all-carbon monocyclic or fused ring (i.e. rings which share an adjacent pair of carbon atoms) group where one or more of the rings does not have a completely conjugated pi-electron system. The cycloalkyl group may be substituted or unsubstituted, as indicated herein. Additionally, the term “cycloalkyl” further encompasses a heterocyclyl ring, as described herein.

The term “aryl” describes an all-carbon monocyclic or fused-ring polycyclic (i.e. rings which share adjacent pairs of carbon atoms) groups having a completely conjugated pi-electron system. The aryl group may be substituted or unsubstituted, as indicated herein.

The term “alkoxy” describes both an O-alkyl and an —O-cycloalkyl group, as defined herein.

The term “aryloxy” describes an —O-aryl, as defined herein.

Each of the alkyl, cycloalkyl and aryl groups in the general formulas herein may be substituted by one or more substituents, whereby each substituent group can independently be, for example, halide, alkyl, alkoxy, cycloalkyl, nitro, amino, hydroxyl, thiol, thioalkoxy, carboxy, amide, aryl and aryloxy, depending on the substituted group and its position in the molecule. Additional substituents are also contemplated.

The term “halide”, “halogen” or “halo” describes fluorine, chlorine, bromine, or iodine.

The term “haloalkyl” describes an alkyl group as defined herein, further substituted by one or more halide(s).

The term “haloalkoxy” describes an alkoxy group as defined herein, further substituted by one or more halide(s).

The term “hydroxyl” or “hydroxy” describes a —OH group.

The term “mercapto” or “thiol” describes a —SH group.

The term “thioalkoxy” describes both an —S-alkyl group, and a —S-cycloalkyl group, as defined herein.

The term “thioaryloxy” describes both an —S-aryl and a —S-heteroaryl group, as defined herein.

The term “amino” describes a —NR′R″ group, with R′ and R″ as described herein.

The term “heterocyclyl” describes a monocyclic or fused ring group having in the ring(s) one or more atoms such as nitrogen, oxygen, and sulfur. The rings may also have one or more double bonds. However, the rings do not have a completely conjugated pi-electron system. Representative examples are piperidine, piperazine, tetrahydrofuran, tetrahydropyran, morpholino and the like.

The term “carboxy” or “carboxylate” describes a —C(O)OR′ group, where R′ is hydrogen, alkyl, cycloalkyl, alkenyl, aryl, heteroaryl (bonded through a ring carbon) or heterocyclyl (bonded through a ring carbon) as defined herein.

The term “carbonyl” describes a —C(O)R′ group, where R′ is as defined hereinabove.

The above-terms also encompass thio-derivatives thereof (thiocarboxy and thiocarbonyl).

The term “thiocarbonyl” describes a —C(S)R′ group, where R′ is as defined hereinabove.

A “thiocarboxy” group describes a —C(S)OR′ group, where R′ is as defined herein.

A “sulfinyl” group describes an —S(O)R′ group, where R′ is as defined herein.

A “sulfonyl” or “sulfonate” group describes an —S(O)2R′ group, where R′ is as defined herein.

A “carbamyl” or “carbamate” group describes an —OC(O)NR′R″ group, where R′ is as defined herein and R″ is as defined for R′.

A “nitro” group refers to a —NO2 group.

The term “amide” as used herein encompasses C-amide and N-amide.

The term “C-amide” describes a —C(O)NR′R″ end group or a —C(O)NR′-linking group, as these phrases are defined hereinabove, where R′ and R″ are as defined herein.

The term “N-amide” describes a —NR″C(O)R′ end group or a —NR′C(O)— linking group, as these phrases are defined hereinabove, where R′ and R″ are as defined herein.

The term “carboxylic acid derivative” as used herein encompasses carboxy, amide, carbonyl, anhydride, carbonate ester, and carbamate.

A “cyano” or “nitrile” group refers to a —CN group.

The term “azo” or “diazo” describes an —N═NR′ end group or an —N═N— linking group, as these phrases are defined hereinabove, with R′ as defined hereinabove.

The term “guanidine” describes a —R′NC(N)NR″R′″ end group or a —R′NC(N) NR″— linking group, as these phrases are defined hereinabove, where R′, R″ and R′″ are as defined herein.

As used herein, the term “azide” refers to a —N3 group.

The term “sulfonamide” refers to a —S(O)2NR′R″ group, with R′ and R″ as defined herein.

The term “phosphonyl” or “phosphonate” describes an —OP(O)—(OR′)2 group, with R′ as defined hereinabove.

The term “phosphinyl” describes a —PR′R″ group, with R′ and R″ as defined hereinabove.

The term “alkylaryl” describes an alkyl, as defined herein, which substituted by an aryl, as described herein. An exemplary alkylaryl is benzyl.

The term “heteroaryl” describes a monocyclic (e.g. C5-C6 heteroaryl ring) or fused ring (i.e. rings which share an adjacent pair of atoms) group having in the ring(s) one or more atoms, such as, for example, nitrogen, oxygen, and sulfur and, in addition, having a completely conjugated pi-electron system. In some embodiments, the terms “heteroaryl” and “C5-C6 heteroaryl” are used herein interchangeably. Examples, without limitation, of heteroaryl groups include pyrrole, furan, thiophene, imidazole, oxazole, thiazole, pyrazole, pyridine, pyrimidine, quinoline, isoquinoline and purine. The heteroaryl group may be substituted or unsubstituted by one or more substituents, as described hereinabove. Representative examples are thiadiazol, pyridine, pyrrole, oxazole, indole, purine, and the like.

As used herein, the terms “halo” and “halide”, which are referred to herein interchangeably, describe an atom of a halogen, that is fluorine, chlorine, bromine, or iodine, also referred to herein as fluoride, chloride, bromide, and iodide.

The term “haloalkyl” describes an alkyl group as defined above, further substituted by one or more halide(s).

As used herein, the term “substituted” or the term “substituent” are related to one or more (e.g. 2, 3, 4, 5, or 6) substituents, wherein the substituent(s) is as described herein. In some embodiments, the term “substituted” or the term “substituent” comprises one or more substituents selected from (C₀-C₆)alkyl-aryl, (C₀-C₆)alkyl-heteroaryl, (C₀-C₆)alkyl-(C₃-C₈) cycloalkyl, optionally substituted C₃-C₈ heterocyclyl, halogen, NO₂, CN, OH, CONH₂, CONR₂, CNNR₂, CSNR₂, CONH—OH, CONH—NH₂, NHCOR, NHCSR, NHCNR, —NC(═O)OR, —NC(═O)NR, —NC(═S)OR, —NC(═S)NR, SO₂R, SOR, —SR, SO₂OR, SO₂N(R)₂, —NHNR₂, —NNR, C₁-C₆ haloalkyl, optionally substituted C₁-C₆ alkyl, NH₂, NH(C₁-C₆ alkyl), N(C₁-C₆ alkyl)₂, C₁-C₆ alkoxy, C₁-C₆ haloalkoxy, hydroxy(C₁-C₆ alkyl), hydroxy(C₁-C₆ alkoxy), alkoxy(C₁-C₆ alkyl), alkoxy(C₁-C₆ alkoxy), C₁-C₆ alkylNR₂, C₁-C₆ alkylSR, CONH(C₁-C₆ alkyl), CON(C₁-C₆ alkyl)₂, CO₂H, CO₂R, —OCOR, —OCOR, —OC(═O)OR, —OC(═O)NR, —OC(═S)OR, —OC(═S)NR, or a combination thereof.

As used herein the term “C₁-C₆ alkyl” including any C₁-C₆ alkyl related compounds, is referred to any linear or branched alkyl chain comprising between 1 and 6, between 1 and 2, between 2 and 3, between 3 and 4, between 4 and 5, between 5 and 6, carbon atoms, including any range therebetween. In some embodiments, C₁-C₆ alkyl comprises any of methyl, ethyl, propyl, butyl, pentyl, iso-pentyl, hexyl, and tert-butyl or any combination thereof. In some embodiments, C₁-C₆ alkyl as described herein further comprises an unsaturated bond, wherein the unsaturated bond is located at 1^{st}, 2^{nd}, 3^{rd}, 4^{th}, 5^{th}, or 6^{th} position of the C₁-C₆ alkyl.

The term “(C₁-C₆) haloalkyl” describes an C₁-C₆ alkyl group as defined herein, further substituted by one or more halide(s), such as chloro, bromo and/or fluoro. In some embodiments, C₁-C₆ haloalkyl is selected from the group comprising —CX₃, —CHX₂, —CH₂X, —CH₂—CX₃, —CH₂—CHX₂, —CH₂—CH₂X, wherein X represents a halo group. In some embodiments, C₁-C₆ haloalkyl is selected from the group comprising —CF₃, —CHF₂, —CH₂F, —CH₂—CF₃, —CH₂—CHF₂, —CH₂—CH₂F.

Each R′ and R independently represents hydrogen, or is selected from the group comprising optionally substituted C₁-C₁₀ alkyl, optionally substituted C₃-C₁₀ cycloalkyl, optionally substituted C₃-C₁₀ heterocyclyl, optionally substituted heteroaryl, optionally substituted aryl or a combination thereof.

### General

As used herein the terms “about” or “approximately” refer to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples which, together with the above descriptions, illustrate the invention in a non-limiting fashion.

### Materials and Methods

PAN ultrafiltration flat sheet membrane (model UN050) was obtained from RisingSun Membrane Technology (Beijing, China). [2-(Methacryloyloxy)ethyl]dimethyl-(3-sulfopropyl)ammonium hydroxide (SBMA; assay ˜95%), N, N′-methylenebisacrylamide (MBA; ˜99%), zinc nitrate hexahydrate (Zn(NO₃)₂·6H₂O, ˜99%), sodium dodecyl sulfate (SDS, ˜98.5%), and calcium chloride (˜98%) were obtained from Sigma Aldrich (Saint Louis, MO, USA); 2-Methylimidazole (2-MIM, ˜98%) and dodecane (˜99+%) from Tokyo Chemical Industry (Tokyo, Japan); potassium metabisulfite (K₂S₂O₅, ˜97%) and potassium persulfate (K₂S₂O₈, ˜99+%) from Acros Organics (USA); ethanol (EtOH), methanol (MeOH), sodium chloride (˜99.5+%), sodium hydroxide (˜99%), and sodium bicarbonate (˜99.7+%) from Bio-Lab Ltd. (Israel); and anhydrous sodium sulfate (˜99%) and magnesium chloride hexahydrate (˜99%) from CARLO ERBA Reagents (France). All solutions were prepared in distilled water unless stated otherwise.

### Membrane Modification

Prior to the membrane modification, the pristine PAN membrane was washed with distilled water, and then it was modified as described below. The pristine PAN membrane (active surface area: 0.0095 m²) was hydrolyzed by treating it with 500 mL of 2 M NaOH aqueous solution at 65° C. for 1 h, then extensively washed with distilled water until pH neutrality. The hydrolyzed membrane is referred to here as the Hy membrane.

ZIF-8 nanoparticles were grown in situ on the active side of the Hy membrane at ambient temperature as follows. The Hy membrane was incubated in an aqueous solution of Zn(NO₃)₂·6H₂O (1.25 g in 50 mL) for 12 h with shaking. The Zn(NO₃)₂·6H₂O aqueous solution was discarded, the membrane was washed with distilled water for 15 seconds, treated with an aqueous solution of 2-MIM (2.75 g in 50 mL) for 1 h with shaking, then gently washed three times with 50% aqueous MeOH. Hy membrane with in situ-grown ZIF-8 nanoparticles is referred to as the HyZif membrane.

Redox-initiated graft polymerization was performed on the active side of the Hy and HyZif membranes at ambient temperature. The membrane (active surface area: 0.00785 m²) was first treated with an aqueous solution of 1.0 M SBMA (40 mL) containing 5 wt. % MBA (as a crosslinker) with shaking for 7.5 min; 0.1 M K₂S₂O₅ and 0.1 M K₂S₂O₈ aqueous solutions (5 mL each) were then added in sequence, and shaking was continued for 30 min. The reaction was terminated by discarding the reaction mixture and extensively washing the membrane with distilled water. The Hy-and HyZif-grafted membranes are referred to as the HyG and HyZifG membranes, respectively.

FTIR spectra of the membrane surfaces were captured using an ATR-FTIR spectrometer (VERTEX 70, Bruker Optiks GmbH, Ettlingen, Germany). XPS analysis was performed using an X-ray photoelectron spectrometer (ESCALAB 250, Thermo Fisher Scientific, United States) equipped with an Al Kα X-ray source and a monochromator under ultrahigh vacuum conditions to determine the surface chemical composition of the membranes. XRD analysis involved Cu Kα radiation (k=1.54 Å) in the 20 range of 10°-38° at a scan rate of 3° min⁻¹ (D/Max Ultima II, Rigaku Corporation, Japan). The surface of the membranes was observed by SEM using a JSM-IT200 instrument (JEOL, Japan). EDX elemental mapping of surface and cross-sectional views of the HyZifG membrane was also performed. The hydrophilic nature of the membranes was studied by measuring water-drop contact angles with an OCA-20 Contact Angle System (DataPhysics Instruments, Filderstadt, Germany) using a 2 μL distilled water drop. The zeta potential of the membranes was measured at different pH values in an asymmetric clamping cell using a SurPASS electrokinetic analyzer (Anton Paar, Graz, Austria). The surface roughness of the membranes was examined by AFM by scanning 5×5 μm membrane areas in QI™ mode with a NanoWizard 4 microscope (JPK Instruments, Bruker Nano GmbH, Berlin, Germany). At least three areas of each membrane were scanned to obtain the root-mean-square roughness (R_{RMS}) value as mean±S.D.

### Pure Water Permeance

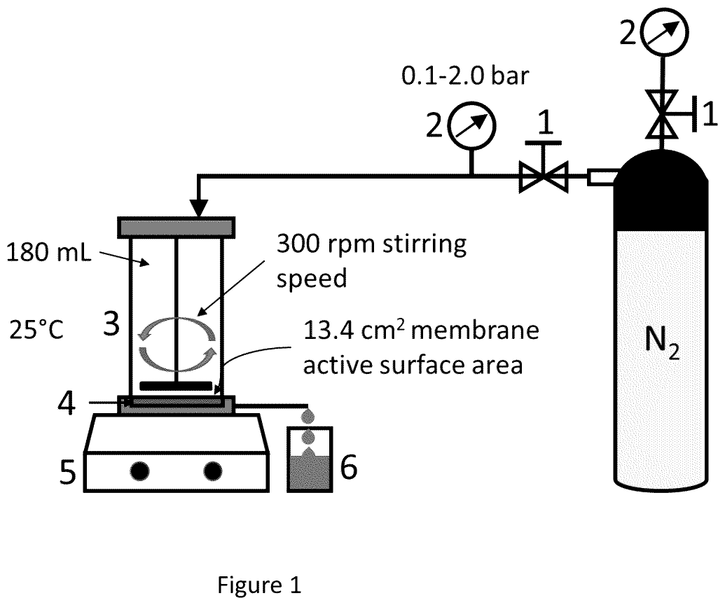

Pure water permeance of the membranes was measured at 1 bar using a dead-end filtration setup (FIG. 1). The measurements were taken after achieving a constant flux with at least 30 min. of filtration, and Equation (1) was used to calculate the pure water permeance of each membrane

$$Pure water permeance = V / ( A \times Δ t ) \qquad ( 1 )$$

where V is the volume of permeate water (L), A is the effective membrane area (0.00134 m2), and Δt is the time duration (h). At least three readings were taken for each membrane, and the respective pure water permeance values are reported as mean±S.D.

### Antifouling Properties of the Membranes for Oilfield PW Treatment and Oil Rejection Efficiency

The antifouling properties and oil rejection efficiency of the membranes were evaluated using a simulated oilfield PW solution based on the composition of real oilfield PW. The solution had a pH of 6.5 and comprised dodecane as the oil component, major ions at concentrations typical of oilfield PW, and SDS as a surfactant (the detailed composition is given in Table 1). The solution was prepared by vigorous stirring for 12 h. Oil droplet size distribution in the prepared simulated oilfield PW was measured by dynamic light scattering (DLS; ALV/CGS-8F Goniometer System, ALV-GmbH, Germany). Based on the measurements performed by the inventor, the simulated oilfield PW had an oil droplet size distribution ranging between 42 nm and 226 nm (data not shown). It may be noted that the simulated oilfield PW, after two days of stirring, also had the oil droplet size distribution ranging between 42.5 nm and 220 nm, similar to the oil droplet size distribution at the beginning of the filtration experiment. Thus, it can be inferred that the feed solution remained stable during the filtration experiments.

TABLE 1
Composition of simulated oilfield PW.

| Parameter | Unit | Value |
|---|---|---|
| Dodecane | g · L⁻¹ | 1.0 |
| Chloride | g · L⁻¹ | 5.2 |
| Bicarbonate | g · L⁻¹ | 0.2 |
| Sulphate | g · L⁻¹ | 1.0 |
| Sodium | g · L⁻¹ | 2.0 |
| Calcium | g · L⁻¹ | 1.0 |
| Magnesium | g · L⁻¹ | 0.4 |
| SDS | g · L⁻¹ | 0.1 |
| pH | — | 6.5 |

The antifouling properties of the PAN, Hy, HyG, and HyZifG membranes were evaluated by dead-end-mode filtration experiments using simulated oilfield PW (see FIG. 1). First, distilled water was filtered through each membrane for 1 h to achieve a stable initial water flux (-100 L·m⁻²·h⁻¹), denoted as J_{W0}. Next, three filtration cycles were performed (foulant filtration, membrane cleaning, and water flux measurement). Each cycle comprised the following steps: Step-1—simulated oilfield PW was filtered for 3 h, and the flux was recorded every minute. At regular time intervals, the collected permeate was added back to the stirred filtration cell to maintain the feed solution concentration constant for the entire step; Step-2—the oilfield PW was discarded, and the membrane was cleaned by 15 min stirring in 80 L distilled water/m² membrane (please note that the distilled water washing step was not included in the filtration cycle time); Step-3—the water flux of the cleaned membrane was measured for 1 h, which was denoted as J_{W1}, J_{W2}, and J_{W3} (L·m⁻²·h⁻¹) for cycle numbers 1, 2, and 3, respectively. Equation (1) was used to calculate the water flux. To elucidate the antifouling properties of the membrane, FRR was calculated for the i^{th} (i=1, 2, 3) filtration cycle using Equation (2):

$$F R {R}_{i} ( \% ) = \frac{{J}_{Wi}}{{J}_{W 0}} \times 100$$

The oil rejection efficiency (Rₑₓₚ) of these membranes was calculated using Equation (3),

$${R}_{exp} ( \% ) = ( 1 - \frac{{C}_{p}}{{C}_{f}} ) \times 100$$

where Cₚ and C_{f} denote the oil concentration in the permeate and feed, respectively, measured using a total organic carbon (TOC) analyzer (Multi N/C 21005, Analytik Jena GmbH, Germany).

The stability of the methacrylate hydrogel-grafted ZIF-8 layer on the HyZifG membrane was examined by comparing the FTIR spectra and EDX elemental analyses before and after the fouling experiments. Furthermore, leaching of ZIF-8 nanoparticles from the HyZifG membrane was detected by collecting retentate (after 15 min of the start of the fouling filtration experiments) and permeate (at regular time intervals) and analyzing them with an inductively coupled plasma-optical emission spectrometer (ICP-OES, SPECTRO ARCOS, AMIETEK, Inc., USA). The limit of detection and quantification of the ICP-OES for zinc is 1 ppb and 10 ppb, respectively.

The HyZifG membrane was selected for conducting long-term antifouling experiments. 10 filtration cycles were performed using the simulated oilfield produced water as the foulant solution. The filtration protocol was the same as described hereinabove.

### Example 1

### Preparation of ZIF-8 Modified Membrane and Stabilizing the ZIF-8 Layer

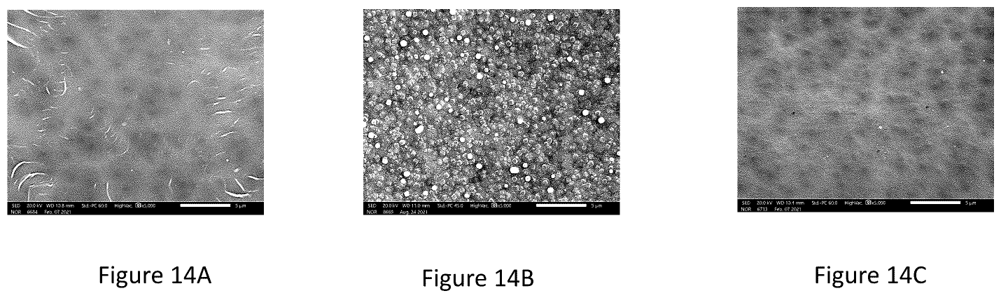

A hydrophilic support membrane should provide high flux, superior oil rejection, and lower fouling than a hydrophobic membrane. Thus, the PAN membrane was chosen as porous support due to its higher hydrophilicity than the PVDF supports. Furthermore, a continuous ZIF-8 nanoparticle layer on the membrane surface formed by in situ growth requires the presence of surface ligand groups such as carboxyl groups. A pristine PAN membrane was thus partially hydrolyzed (Scheme 1, Step 1) to introduce surface carboxyl groups to provide sufficient anchoring sites to form a continuous ZIF-8 nanoparticle layer on the membrane surface (Scheme 1, Step 2) [34]. The coverage of the Hy membrane surface by the ZIF-8 nanoparticles layer can be seen by the SEM analysis (FIG. 14A-C). It is pertinent to note that the in situ growth of the ZIF-8 nanoparticles was performed on the membrane surface under conditions (at room temperature in water) compatible with porous UF membranes.

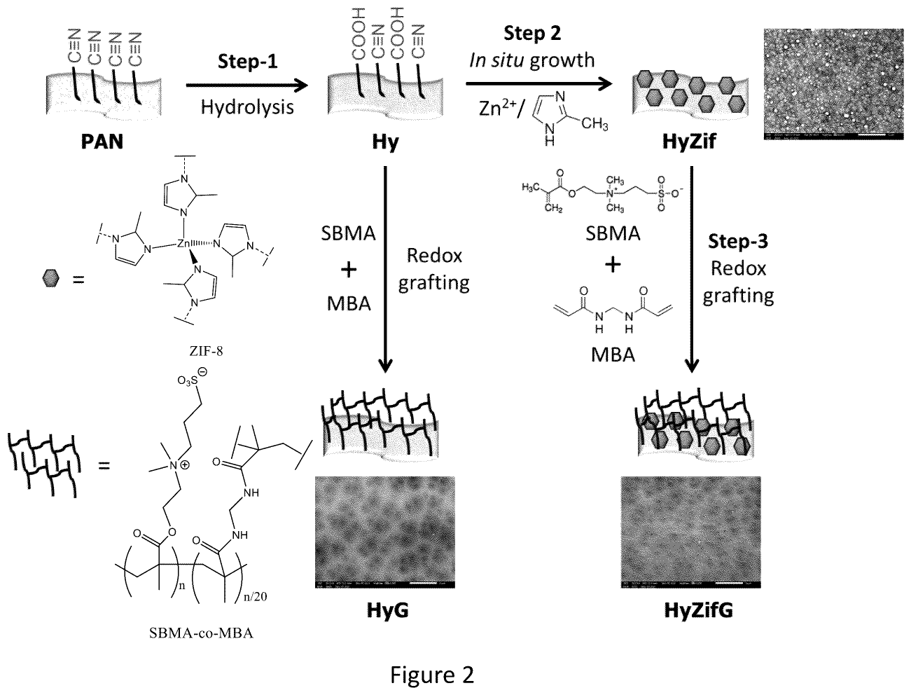

Finally, for stabilizing the ZIF-8 layer chemically, a crosslinked zwitterionic hydrogel containing sulfonate groups was introduced. Redox-initiated graft polymerization introduced a methacrylate zwitterionic hydrogel over the ZIF-8 layer to maintain the integrity and stability of the ZIF-8 layer (FIG. 2, Step 3). The coating of the ZIF-8 nanoparticles layer by redox-grafted methacrylate hydrogel can be seen in the SEM image (FIG. S4-E). The membranes were characterized using various techniques to elucidate their physicochemical properties, and their performance in oilfield PW treatment was studied.

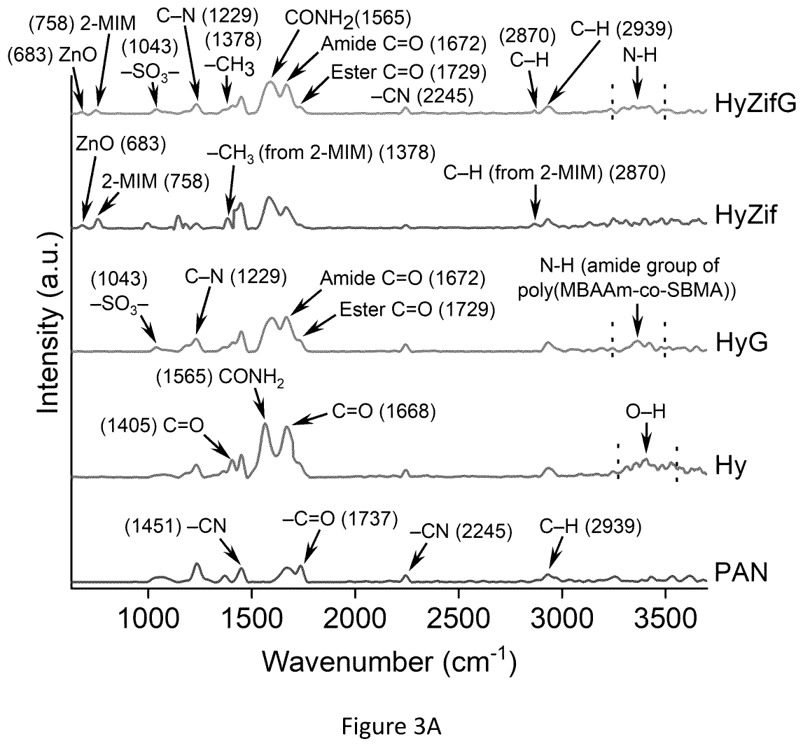

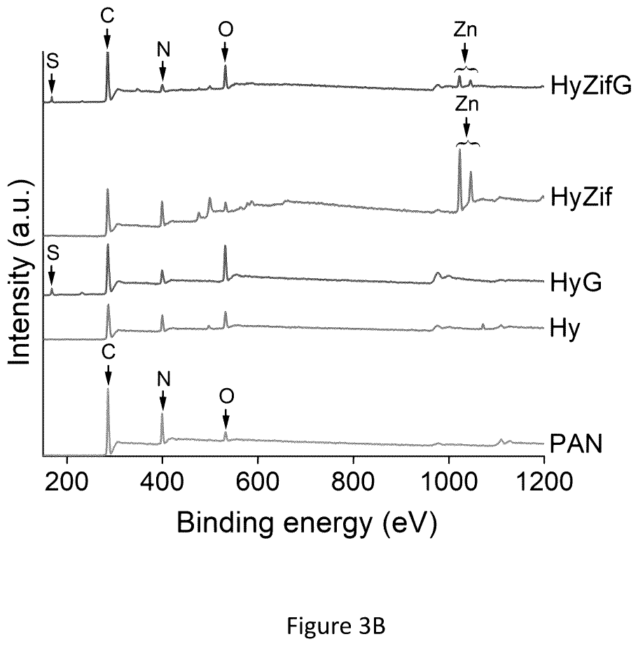

FIG. 3 shows the FTIR spectra of the modified membranes compared to the pristine PAN membrane. The FTIR spectrum of the pristine PAN membrane had peaks at 1451 cm⁻¹ and 2245 cm⁻¹, corresponding to the C—N stretching of the —C≡N group. Further, the peak at 2939 cm⁻¹ corresponds to C—H stretching. An additional peak at 1737 cm⁻¹ corresponds to carbonyl —C═O stretching (in carboxylic acids or esters) and may be due to additives present in commercial PAN membranes. Hydrolysis of the PAN membrane (Hy membrane) resulted in prominent peaks at 1565 cm⁻¹ and 1668 cm⁻¹, corresponding to the NH group in carboxamide and the carbonyl group (C═O) [39, 40], and a new peak at 1405 cm⁻¹ indicating a carboxyl group on the Hy membrane surface [40]. Additionally, peaks appearing between 3200-3500 cm⁻¹ corresponded to the O—H moieties of carboxyl groups on the membrane surface. The appearance of these peaks confirmed partial hydrolysis of the PAN membrane. In situ growth of ZIF-8 nanoparticles on the Hy membrane provided HyZif membrane (FIG. 3), which showed peaks characteristic of ZIF-8 nanoparticles at 683 cm⁻¹, 758 cm⁻¹, 1378 cm⁻¹, and 2870 cm⁻¹ corresponding to the stretching vibrations of the ZnO bond in octahedral coordination, the bending vibration of the imidazole ring, the bending vibration of the —CH₃ group in 2-methylimidazole, and aliphatic C—H stretch of the imidazole ring, respectively. The appearance of these peaks confirmed the presence of ZIF-8 nanoparticles on the membrane surface. Grafting poly(methacrylate) hydrogel on Hy membrane provided HyG membrane with peaks at 1043 cm⁻¹ (sulfonate S═O stretch), 1229 cm⁻¹ (CO—NH stretching vibration of the amide group), 1672 cm⁻¹ (amide C═O), 1729 cm⁻¹ (ester C═O stretch), and broad peaks between 3250-3450 cm⁻¹ corresponding to the stretching vibration of N—H in the amide groups of poly(MBA-co-SBMA). The appearance of these peaks confirmed the presence of grafted methacrylate hydrogel on the membrane surface. The FITR spectrum of the HyZifG membrane had peaks characteristic of the ZIF-8 nanoparticles (observed in the FTIR spectrum of the HyZif membrane) and from grafted methacrylate hydrogel (observed in the FTIR spectrum of the HyG membrane), confirming modification of the membranes with the ZIF-8 nanoparticles and grafted hydrogel. These various groups on the surface of the membranes affect the surface properties of the membranes and thus their separation performance, as discussed later.

The surface elemental composition of the prepared membranes was quantified using XPS analysis (Table S1).

TABLE S1
Surface elemental composition (atomic %) of different
membranes obtained by XPS analysis^{a}.

| Membrane | C | O | N | S | Zn |
|---|---|---|---|---|---|
| PAN | 75.73 | 4.89 | 19.38 | N.d. | N.d. |
| Hy | 71.91 | 12.57 | 15.52 | N.d. | N.d. |
| HyG | 67.03 | 19.31 | 10.75 | 2.92 | N.d. |
| HyZif | 66.71 | 5.28 | 19.06 | N.d. | 8.95 |
| HyZifG | 76.91 | 13.27 | 6.63 | 1.41 | 1.78 |

^{a}N.d., not detected.

The XPS wide spectra of these membranes are also shown in FIG. 3B. It can be inferred from the results that the O-content increased with the hydrolysis of the pristine PAN membrane, indicating the higher presence of oxygen-enriched surface groups on the Hy membrane compared to the pristine PAN membrane. With the grafting of poly(methacrylate) hydrogel, the HyG membrane showed S-content, owing to the sulfonic acid group in the SBMA polymer, which confirms the membrane modification with the grafted methacrylate hydrogel. The appearance of Zn in the HyZif membrane, which was accompanied by low oxygen and elevated nitrogen contents, confirm the in situ grown ZIF-8 nanoparticles on the membrane surface. The grafting on the HyZif membrane with the methacrylate hydrogel (HyZifG membrane) masked the ZIF-8 layer, which resulted in decreased Zn-content, the reappearance of sulfur, and elevated oxygen, for the HyZifG membrane. Therefore, the XPS surface analysis confirms the successful modifications of the membranes.

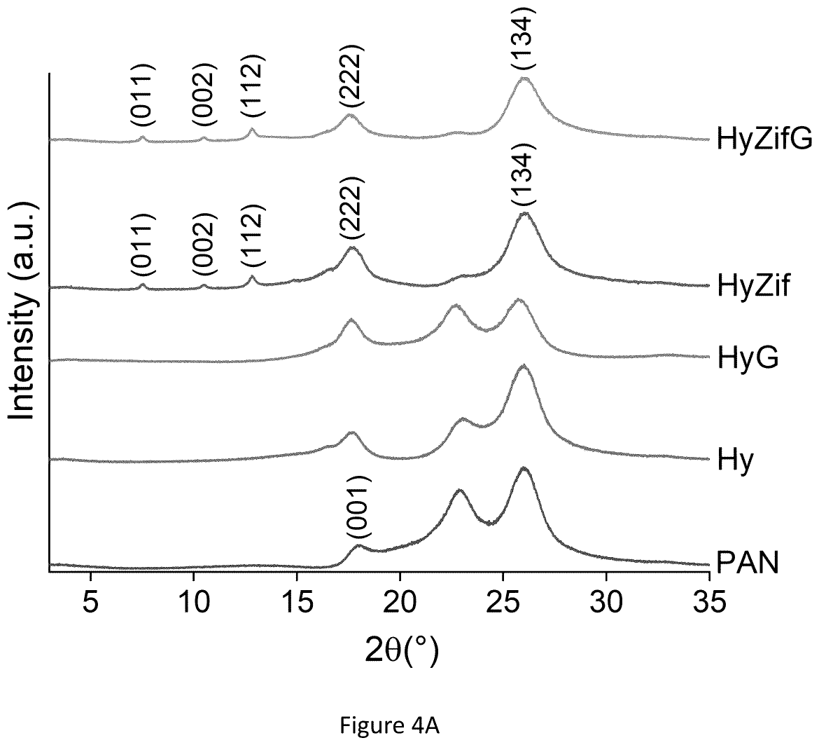

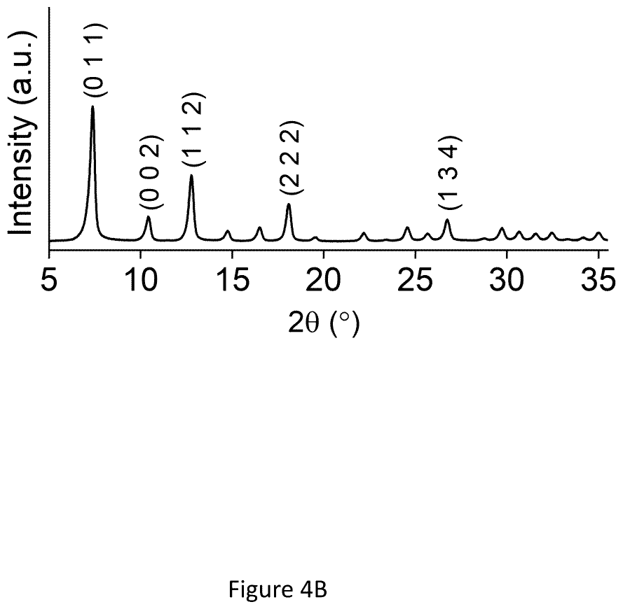

FIG. 4 shows the XRD spectra of the prepared membranes. The PAN membrane spectrum had three peaks, with that at 2θ=18° being characteristic of the hexagonal crystal of PAN, and the other two peaks, at 2θ=22.8° and 26.1°, possibly being attributable to the crystalline phase of the PAN membrane. These peaks were also observed, with minor variations in intensity, for the Hy and HyG membranes. The intensity of the peak at 2θ=22.8° was substantially reduced in the HyZif and HyZifG membranes compared to the pristine membrane because of the presence of a coating layer of ZIF-8 nanoparticles, which masked the underlying PAN support. HyZif membrane provided several diffraction peaks attributed to ZIF-8 nanoparticles at 2θ=7.5°, 10.5°, and 12.8°, corresponding to (011), (002), and (112) reflections, respectively (XRD spectrum of the pristine ZIF-8 nanoparticles is shown in FIG. 4B). Additionally, two diffraction peaks appeared at 2θ=17.8° and 26.1°, corresponding to (222) and (134) reflections, respectively, and coinciding with peaks recorded in the spectrum of pristine PAN. These peaks were also recorded for the HyZifG membrane, confirming the overall modification of the PAN membrane with a methacrylate hydrogel-grafted ZIF-8 layer.

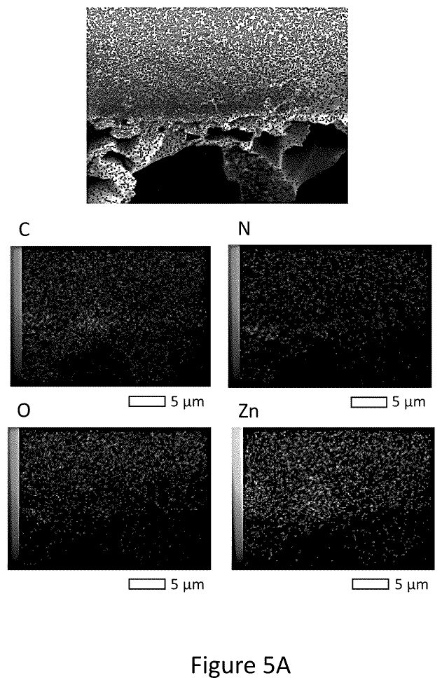

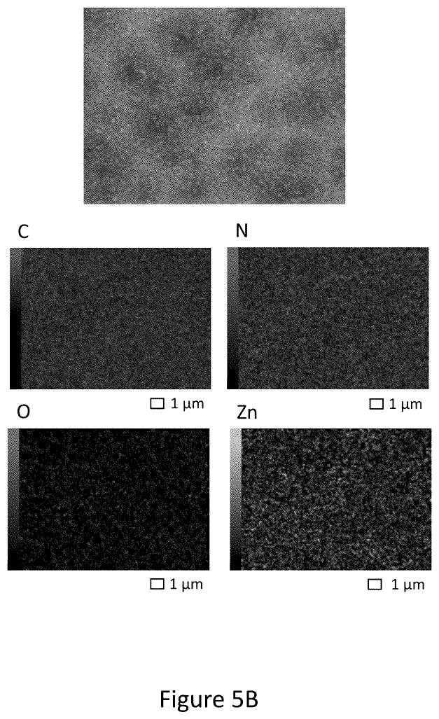

EDX elemental mapping of a cross-section and the surface of the HyZifG membrane was performed to explore the distribution of the ZIF-8 nanoparticles on the membrane. FIGS. 5A-B show the microscopic maps of C, N, O, and Zn on the HyZifG membrane. Element, Zn, is a characteristic component of ZIF-8 nanoparticles and confirmed the presence of a ZIF-8 layer stabilized by a methacrylate hydrogel layer on the membrane surface.

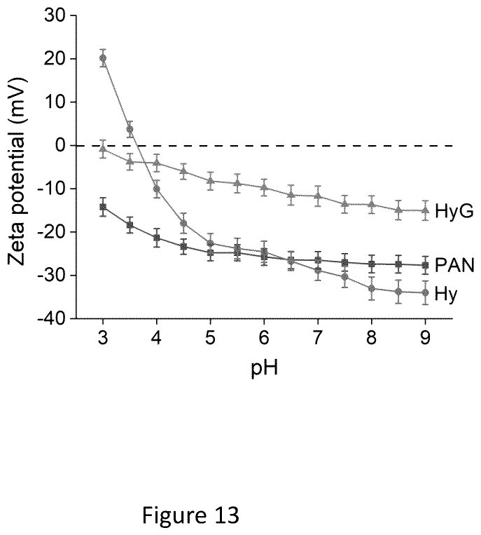

The surface charge of a membrane is crucial for separation applications, and the zeta potential of the PAN, Hy, and HyG membranes was measured using the streaming potential method (FIG. 13). All membranes had a net negative surface charge at pH values above 4.0, with the pristine PAN and Hy membranes showing the most negative values. However, the Hy membrane exhibited a sharp titration slope in the range of pH 3.0-5.5 (the isoelectric point is pH 4.0), which is typical of carboxyl titration and provides a clear indication of a high concentration of carboxyl groups on the Hy membrane surface. Redox-initiated graft polymerization on the Hy membrane provided the HyG membrane, which exhibited an overall decrease in negative surface charge (less negative zeta potential) compared to the pristine membrane, likely due to the zwitterionic-neutral nature of the SBMA monomer used in the polymerization reaction and partial masking of the membrane surface. The zeta potential measurements confirm the successful hydrolysis of the pristine PAN membrane and subsequent modification with a methacrylate hydrogel. Furthermore, at pH 6.5, the working pH for the antifouling experiments, the zeta potential value for the HyZifG membrane was −14.5±−0.6 mV, indicating that all the studied membranes had negative zeta potential values at the working pH.

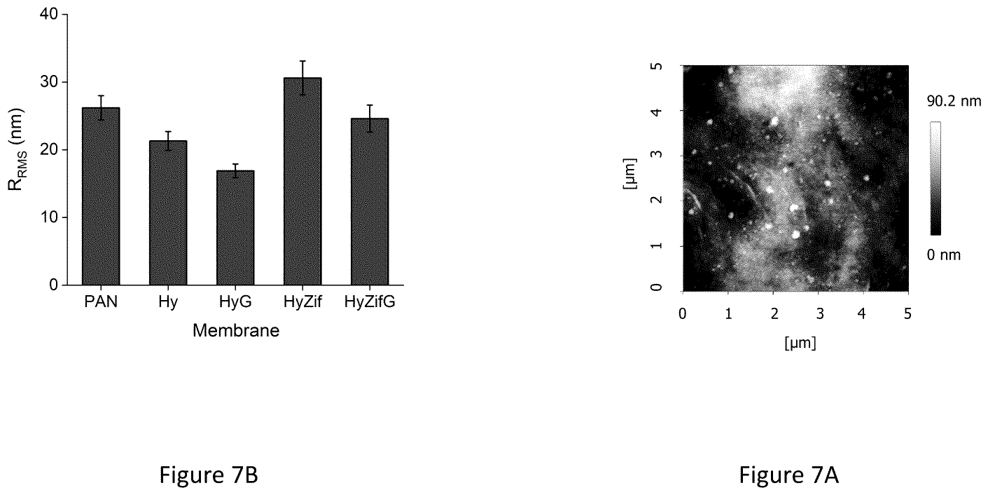

Surface roughness is an important property of membranes used for separation applications and may impact the tendency for membrane fouling. AFM was used to measure the membrane surface roughness in terms of R_{RMS} (FIG. 7). The pristine PAN membrane gave an R_{RMS} value of 26.2±1.8 nm, which decreased to 21.3±1.4 nm for the Hy membrane, showing that hydrolysis smoothed the membrane surface. The roughness was further reduced to 16.9±1.0 nm for the HyG membrane due to the methacrylate hydrogel layer coating via redox-initiated graft polymerization. The AFM analyses were conducted in water, where the hydrogel layer is swollen and would thus be expected to provide a smooth surface. In situ growth of ZIF-8 nanoparticles on the Hy membrane surface increased the roughness of the HyZif membrane to 30.6±2.5 nm due to the heterogeneous surface formed by the ZIF-8 nanoparticles. Redox grafting by the methacrylate hydrogel reduced the surface roughness to 24.6±2.0 nm for the HyZifG membrane, consistent with the reduced roughness of the HyG membrane compared with the Hy membrane. The interplay between the wettability and roughness of a membrane will affect its separation performance for treating oilfield PW and its antifouling behavior, as discussed later.

### Example 2

### Membrane Performance

The performance of the exemplary membranes of the invention (prepared according to above described process) in oilfield PW treatment was studied in terms of pure water permeance, antifouling properties, and oil rejection efficiency.

### Pure Water Permeance

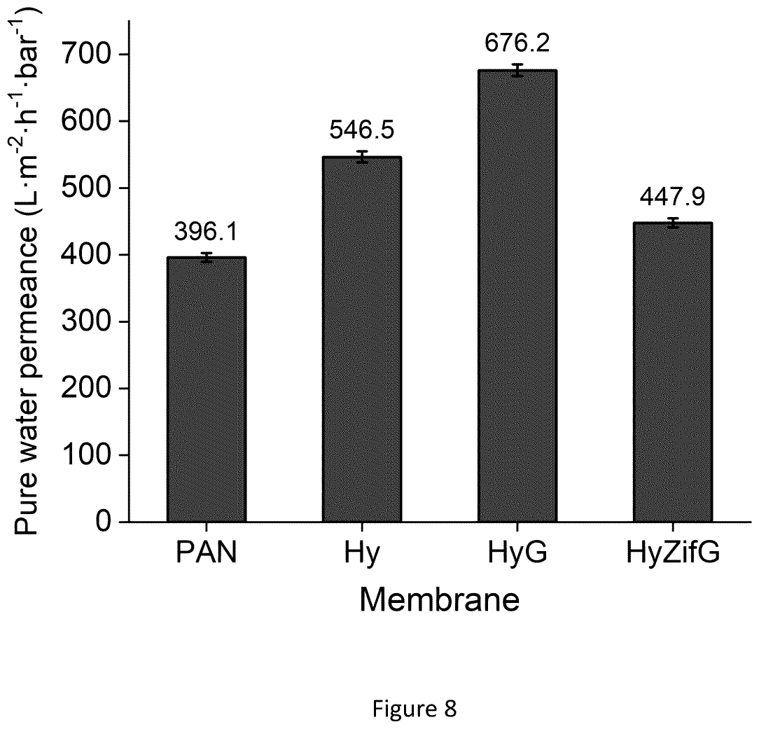

High pure water permeance is desirable for separation applications. FIG. 8 shows the pure water permeance of the prepared membranes. The pure water permeance of the PAN membrane was 396.1±6.5 L·m-2·h-1·bar-1, increasing to 546.5±8.3 L·m-2·h-1·bar-1 (138% increase) and 676.2±8.7 L·m-2·h-1·bar-1 (171% increase) for the Hy and HyG membranes, respectively. These increases in pure water permeance can be attributed to the hydrophilic nature of the membranes, evident from their water contact angle values, owing to the presence of water-attracting functional groups on the membrane surface, as discussed in the FTIR study (FIG. 3). The pure water permeance of the HyZifG membrane was 447.9±6.7 L·m-2·h-1·bar-1, ˜13% higher than that of pristine PAN membrane, consistent with its higher hydrophilicity, and is desirable for separation applications. The pure water permeance of HyZifG was lower than that of the Hy and HyG membranes due to its relatively lower hydrophilic nature (higher water contact angle).

### Antifouling Properties for Oilfield PW Filtration

The composition and nature of PW from the oil and gas industry vary depending on the geographic location of the site and the drilling technology used. The inventors compiled information from various sites, and a test solution was designed with a chemical composition typical of oilfield PW in terms of major ions, pH, and salinity, using dodecane as the hydrocarbon component (see detailed composition and properties in Table 1). Antifouling experiments were conducted by filtering the simulated oilfield PW through the PAN, Hy, HyG, and HyZifG membranes to elucidate the specific antifouling contribution of PAN hydrolysis, redox-initiated graft polymerization, and ZIF-8 layer on membrane overall performance.

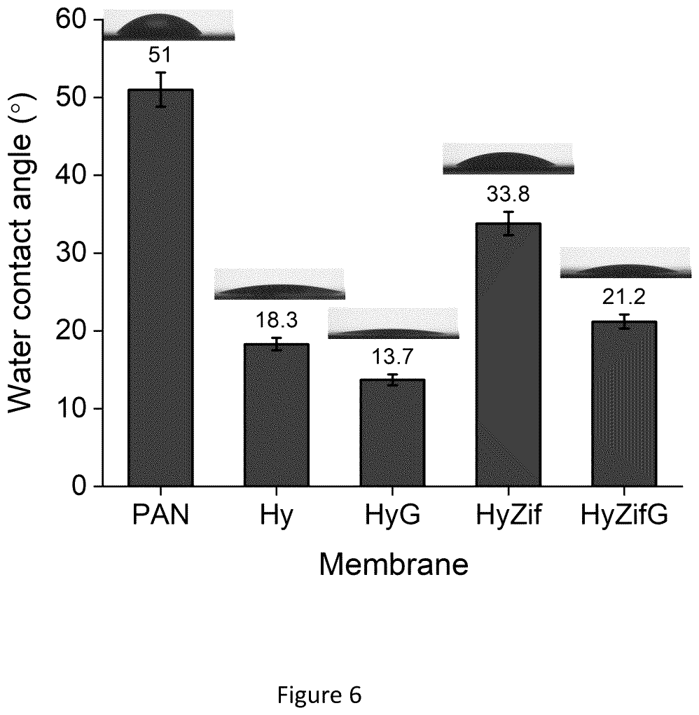

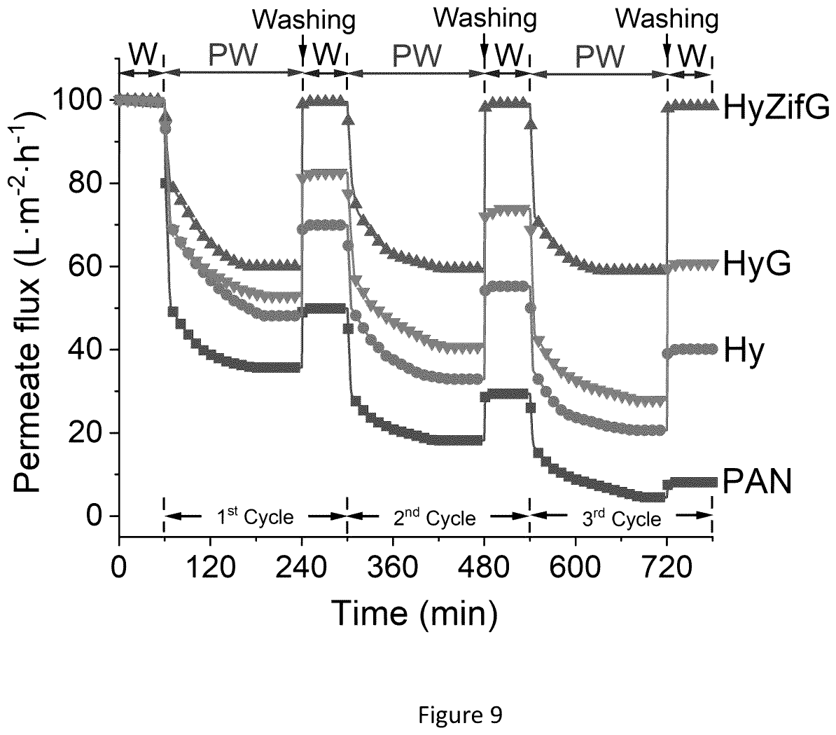

FIG. 9 shows the filtration of simulated oilfield PW by the different membranes to determine their membrane antifouling behavior. A stable initial permeate flux (100 L·m⁻²·h⁻¹) was obtained for all the membranes by regulating the pressure. As the fouling experiment progressed, the flux of each membrane changed depending on its antifouling characteristics. Three cycles of filtration are shown in FIG. 9. The antifouling behavior of the membranes is presented in terms of FRR in Table 2. It is evident from the data that the pristine PAN membrane was prone to fouling since the FRR significantly decreased with each fouling cycle (FRR=49.9±0.9%, 29.4±0.6%, and 8.1±0.7% for the first, second, and third fouling cycles, respectively). The Hy and HyG membranes (modified by hydrolysis and graft polymerization, respectively) provided FRR values, which were incrementally improved compared to the pristine PAN membrane, indicating that all modification steps aided antifouling behavior. The FRR values for the Hy membrane (69.9±1.4%, 55.2±1.5%, and 40.1±1.7% for the first, second, and third fouling cycle, respectively) were higher than those calculated for the pristine PAN membrane, and the FRR values for the HyG membrane were 82.5±1.3%, 73.8±1.6%, and 61.7±1.5%, respectively. The observed trend was, therefore, FRR(HyG)>FRR(Hy)>FRR(PAN), reflecting the hydrophilic nature and surface roughness of the Hy and HyG membranes. A hydrophilic membrane with a smooth surface facilitates the formation of a hydration layer on the membrane surface, which resists the deposition of foulants, and thus exhibits high antifouling properties. The inventors observed that the membrane hydrophilicity (evident from the water contact angle values, FIG. 6) and surface smoothness (membrane surface roughness, R_{RMS} values, FIG. 7) followed the trend HyG>Hy>PAN, consistent with their antifouling performance. Significantly, the HyZifG membrane exhibited outstanding antifouling performance for the filtration of oilfield PW (the foulant), with an excellent antifouling capacity as shown by FRR values of 99.5±0.5%, 99.1±0.7%, and 98.5±0.6% for the first, second, and third fouling cycle, respectively. The HyZifG membrane showed the extraordinary ability to regain its original flux, with only minor loss, immediately after cleaning the membrane surface by washing (stirring for 15 min in distilled water).

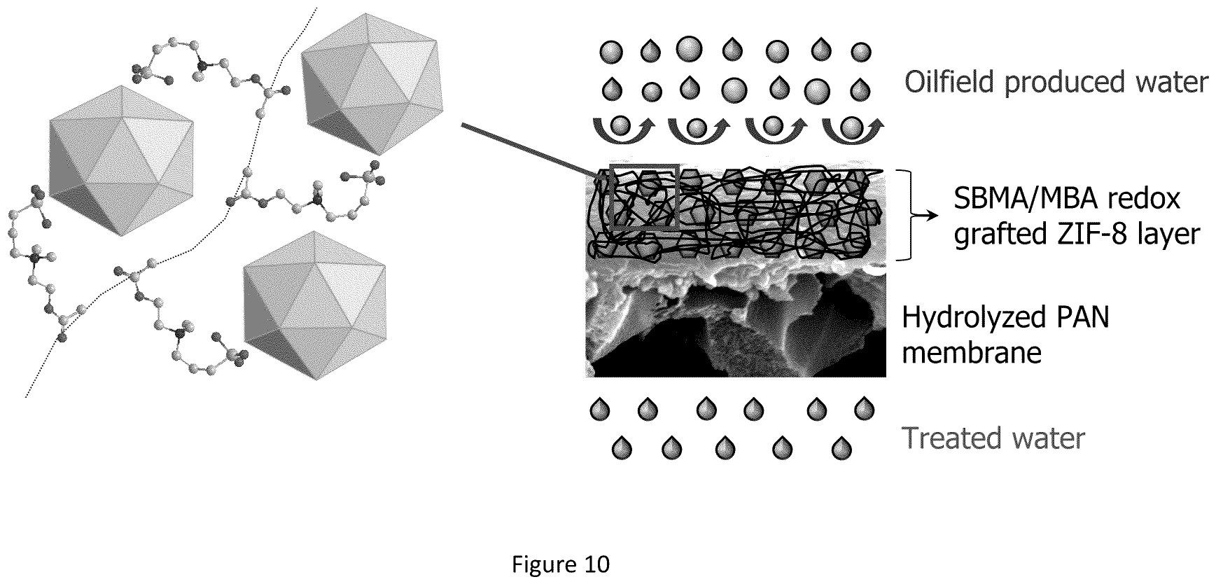

The good antifouling behavior of the HyZifG membrane can be attributed to the presence of the methacrylate hydrogel-grafted ZIF-8 layer on the membrane surface, which is hydrophilic and provides strong resistance to adherence of the oily foulants on the membrane surface. Further, low MWCO value (Table S2), due to the presence of methacrylate hydrogel-grafted ZIF-8 layer on the HyZifG membrane, could prevent the pore blocking by the oily foulants and preferentially allow water to penetrate through the membrane, resulting in the membrane's high water flux (FIG. 10). Therefore, the HyZifG membrane showed the best antifouling performance.

TABLE 2
Flux recovery ratio (FRR) values for the PAN, Hy, HyG, and
HyZifG membranes after each simulated oilfield PW^{a} filtration
cycle. The values are expressed as mean ± S.D, n = 3.

| | First-cycle FRR | Second-cycle FRR | Third-cycle FRR |
|---|---|---|---|
| Membrane | (%) | (%) | (%) |
| PAN | 49.9 ± 0.9 | 29.4 ± 0.6 | 8.1 ± 0.7 |
| Hy | 69.9 ± 1.4 | 55.2 ± 1.5 | 40.1 ± 1.7 |
| HyG | 82.5 ± 1.3 | 73.8 ± 1.6 | 61.7 ± 1.5 |
| HyZifG | 99.5 ± 0.5 | 99.1 ± 0.7 | 98.5 ± 0.6 |

^{a}Solution chemical composition is detailed in Table 1.

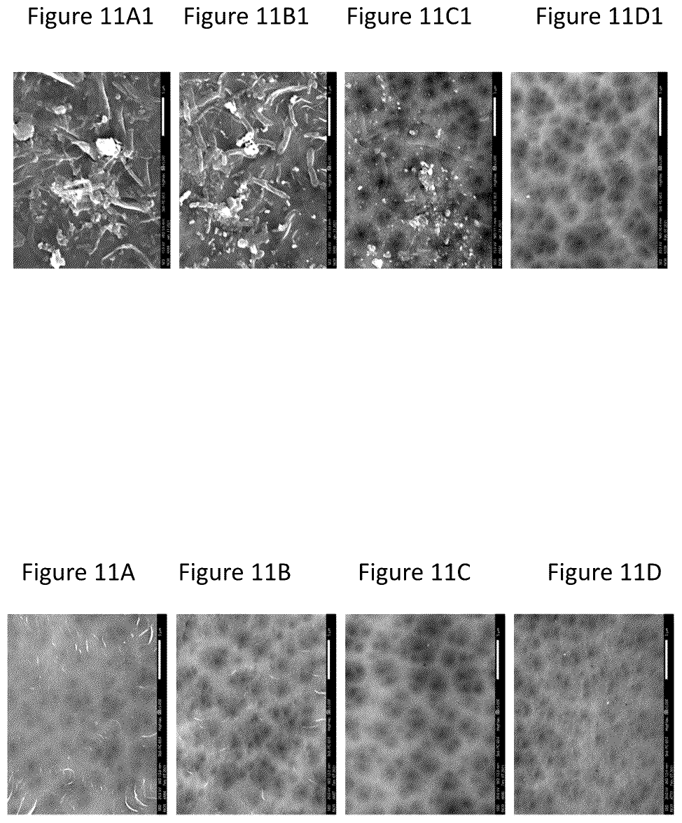

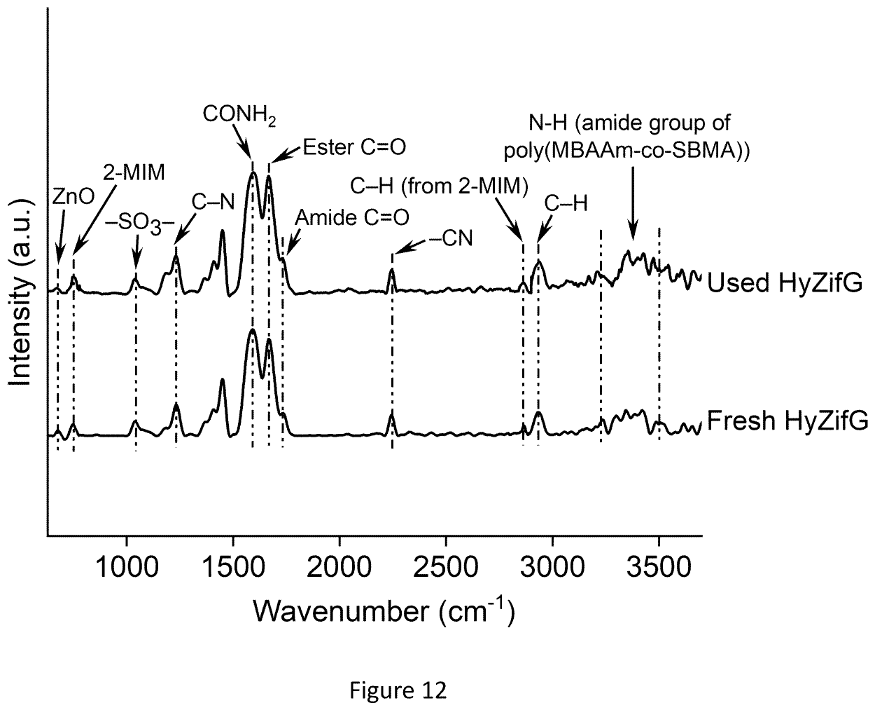

The observed trend in the antifouling performance of the membranes for filtering oilfield PW was further supported by an SEM study of their surface before and after filtration (FIG. 11). The SEM images indicate that the surface of the pristine PAN membrane had the highest amount of foulant attachment. In contrast, the HyZifG membrane showed negligible attachment of foulants, supporting its superior antifouling properties for oilfield PW. The HyZifG membrane remained stable even after three 4-h filtration cycles, as determined by comparing the FTIR spectra of the membrane before and after the fouling experiments (FIG. 12). The FTIR spectrum of the HyZifG membrane after filtration showed all the major characteristic peaks of ZIF-8 nanoparticles observed using a fresh membrane (before the start of the fouling experiments), confirming that the ZIF-8 layer on the membrane surface remained intact even after performing all the filtration experiments. Moreover, the EDX elemental composition of the fresh and used HyZifG membrane remained almost the same (Table S3), indicating the stability of the ZIF-8 layer under the methacrylate hydrogel on the HyZifG membrane. Further, the leaching of ZIF-8 nanoparticles from the HyZifG membrane during the fouling experiments was examined by measuring Zn²⁺ concentration in the retentate and permeate with an ICP-OES. The ICP-OES analyses did not detect Zn²⁺ in the retentate and permeate below the ICP's detectable limit (1 ppb), implying the hydrostability of the ZIF-8 layer in the HyZifG membrane during the antifouling filtration experiments and under the ICP analytical thresholds.

The oil rejection efficiency (Rₑₓₚ) of the prepared membranes was found to follow the same trend as their antifouling performance. The HyZifG membrane had the highest value (99.7±0.3%), followed by the HyG membrane (97.5±0.6%), Hy membrane (96.9±0.7%), and pristine PAN membrane (96.5±0.5%). The trend of the rejection values of different membranes is consistent with their MWCO values (Table S2). The pristine PAN membrane had the highest MWCO value (325.4 kDa) and showed an oil rejection value of 96.5±0.5%. On the other hand, the HyZifG membrane had the lowest MWCO value (265.2 kDa), which showed the highest oil rejection value (99.7±0.3%), followed by the HyG membrane (97.5±0.6%) and Hy membrane (96.9±0.7%), which had MWCO values of 305.6 and 310.7 kDa, respectively. Clearly, the size exclusion is the dominant separation mechanism by the four membranes tested. The superior oil rejection efficiency of the HyZifG membrane can be attributed to the presence of the ZIF-8 layer, which resulted in lowering the MWCO value and thus hindered the passage of oil through the membrane [10, 51, 52]. The rejection rates of the ions in the simulated PW solution by the membranes were measured using ICP analysis of the feed and permeate and are given in Table S4. The obtained rejection values were in the range of 1%-16%, with the highest rejection values measured for the HyZifG membrane. Low rejection values of inorganic ions are expected for a UF membrane.

Antifouling performance of the HyZifG membrane was examined for 42 h (10 filtration cycles) and is presented in FIG. 13. After 10 filtration cycles, the HyZifG membrane showed an FRR value of 90.3%. Here, the gradual decrease in the FRR values after each filtration cycle can be attributed to pore blockage by the foulants with time. Notably, the oil rejection efficiency remained >99% throughout the filtration duration. These results clearly signify that the HyZifG membrane exhibits promising suitability for the treatment of oilfield produced water.

The performance of the HyZifG membrane in treating oilfield PW is compared with those of previously reported membranes for oily wastewater treatment. Performance of an exemplary membrane of the invention is demonstrated in Table 3. As indicated in Table 3 exemplary HyZifG membrane of the invention showed excellent antifouling capacity (FRR ˜90.3%) and oil rejection efficiency (>99%) for the oilfield PW treatment.

TABLE 3
Performance of the HyZifG membrane described
herein in the treatment of oilfield PW.

| | Oil | Filtration | Flux | Oil rejection |
|---|---|---|---|---|
| Membrane | component | monitoring/ | recovery | efficiency |
| material | (concentration) | duration | ratio (%) | (%) |
| Methacrylate | Dodecane | 2520 min. | 90.3 | >99 |
| hydrogel- | (oilfield PW) | | | |
| stabilized | (1 g · L⁻¹) | | | |
| ZIF-8 layer | | | | |
| on PAN | | | | |
| membrane | | | | |

Overall, the results presented and discussed here demonstrate the successful design and preparation of the HyZifG membrane and that the membrane has excellent antifouling properties, high water flux, high oil-removal efficiency, and stability during filtration. The described polyacrylonitrile membrane with a methacrylate hydrogel-grafted ZIF-8 layer, prepared using a facile method, thus holds promise for the separation and treatment of oilfield PW.

### Molecular Weight Cut Off (MWCO) Analysis

The MWCO of membranes was determined using polyethylene glycol (Mₙ=35 kDa; Sigma Aldrich, MO, USA) and polyethylene oxide (Mₙ=100, 200, 400, and 600 kDa; Sigma Aldrich, MO, USA) as molecular markers. 1 g·L⁻¹ solution of each molecular marker was separately prepared in Milli-Q water and separately filtered through the membranes at room temperature using an Amicon® stirred dead-end filtration cell (300 rpm) at 1 bar. The concentration of the molecular markers was measured in the feed and the permeate by measuring the total organic carbon (TOC) concentration of the feed (C_{f}) and permeate (Cₚ) solutions using a TOC analyzer (Multi N/C, 2100S, Analytikjena, Germany). Percentage rejection of a marker was calculated using the following equation (S1) and plotted against its molecular weight:

$$R ( \% ) = ( 1 - \frac{{C}_{p}}{{C}_{f}} ) \times 100 \qquad ( S 1 )$$

The MWCO value, defined as the molecular weight for 90% rejection, for each membrane was calculated from the rejection vs. molecular weight graph. The MWCO values of different membranes are given in Table S2.

TABLE S2
MWCO data of different membranes.

| Membranes | MWCO (kDa) |
|---|---|
| PAN | 325.4 |
| Hy | 310.7 |
| HyG | 305.6 |
| HyZifG | 265.2 |

TABLE S3
EDX elemental composition (in mass %)
of the fresh and used HyZifG membrane.

| Element | Fresh HyZifG | Used HyZifG |
|---|---|---|
| C | 54.89 ± 0.36 | 55.02 ± 0.55 |
| N | 18.36 ± 0.50 | 18.34 ± 0.47 |
| O | 19.28 ± 0.29 | 19.22 ± 0.37 |
| S | 2.97 ± 0.05 | 2.96 ± 0.06 |
| Zn | 4.50 ± 0.11 | 4.46 ± 0.15 |

TABLE S4
Rejection (%) values of ions from different membranes.

| Membrane | Chloride | Sodium | Sulphate | Calcium | Magnesium |
|---|---|---|---|---|---|
| PAN | 4.6 | 2.7 | 2.6 | 2.2 | 1.4 |
| Hy | 5.3 | 3.6 | 3.0 | 2.5 | 1.9 |
| HyG | 8.3 | 5.4 | 4.1 | 4.0 | 2.9 |
| HyZifG | 15.3 | 8.7 | 8.4 | 7.6 | 6.8 |

### Example 3

Stabilized COF-300 Nanoparticles on Polymeric Membranes for Efficient Removal of PFAS Pollutants from Contaminated Water

COF-300 nanoparticles were prepared as follows: 0.053 mmol tetrakis(4-aminophenyl)methane (TAPM) was fully dissolved in 1,4-dioxane, and the mixture was heated for 5 min at 50-60° C. After cooling the solution to room temperature, 1.7 mmol acetic acid and water were mixed and added to the above mixture. Terephthaldehyde (TPA; 0.089 mmol) was dissolved in dioxane and added to the TAPM solution. The mixture was kept at 120° C. for 72 h. The reaction mixture was allowed to cool to room temperature. The resulting yellow solid was then washed as per the following protocol: (1) 3-times centrifugation using 1,4-dioxane; (2) shaking in 1,4-dioxane for 24 h; (3) centrifugation to discard 1,4-dioxane; (4) 3-times centrifugation using isopropanol; (5) shaking in isopropanol for 24 h; (6) centrifugation to discard isopropanol. Finally, it was vacuum dried at 60° C. for 24 h.

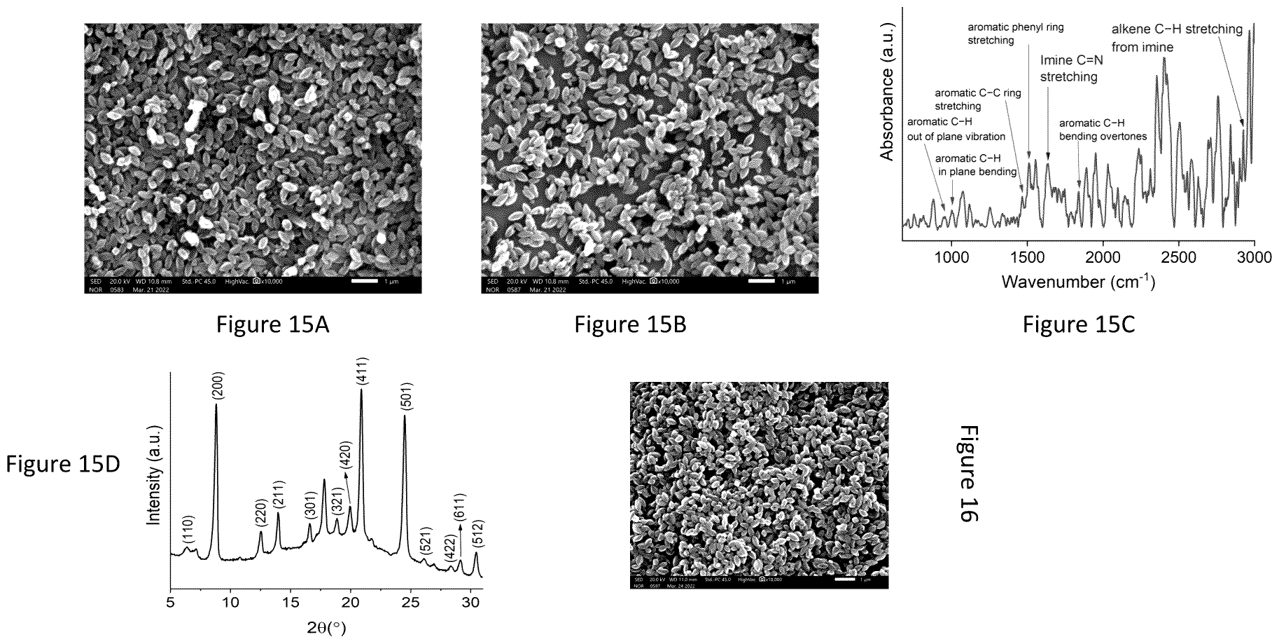

The prepared nanoparticles were characterized for their morphology by scanning electron microscopy (SEM), for their chemical functionality by the Fourier-transform infrared spectroscopy (FTIR), and their crystallinity by the X-ray diffraction (XRD) spectroscopy. The SEM images (FIGS. 15(A-B)) show the oblong shape of the COF nanoparticles. The FTIR spectrum of the prepared nanoparticles is presented in FIG. 1-C, showing the characteristic peaks of COF-300 nanoparticles at 1625 cm⁻¹ (attributed to imine C═N stretching) and 2926 cm⁻¹ (attributed to alkene C—H stretching from imine), confirming their structure [Uribe-Romo et al. Journal of the American Chemical Society 131 (2009) 4570-4571]. Other important peaks were also recorded at 947 cm⁻¹ (aromatic C—H out of plane vibration from TAPM), 1007 cm⁻¹ (aromatic C—H in-plane bending from TAPM), 1480 cm⁻¹ (aromatic C—C ring stretching from phenyl ring), 1512 cm⁻³ (aromatic ring stretching from phenyl rings in TAPM), and 1836 cm⁻¹ (aromatic C—H bending overtones).

FIG. 15-D shows the XRD pattern of the COF-300 nanoparticles. The characteristic peaks appeared at 6.3° (110), 8.8° (200), 12.5° (220), 13.9° (211), 16.6° (301), 18.9° (321), 19.9° (420), 20.8° (411), 24.5° (501), 26° (521), 28.3° (422), 29.1° (611), and 30.5° (512) [Uribe-Romo et al. Journal of the American Chemical Society 131 (2009) 4570-4571], which confirmed the successful synthesis of the COF-300 nanoparticles. PAN UF membrane was hydrolyzed as described hereinabove (Example 1 and material and methods).

Then, the COF-300 nanoparticles were deposited on the hydrolyzed PAN membrane by vacuum filtration. The loading of the COF-300 nanoparticles was 20 μg·cm². FIG. 16 shows the SEM image of the COF-300 nanoparticles deposited on the membrane surface. Next, the redox-initiated graft polymerization was performed on the membrane surface, as described hereinabove (Example 1 and material and methods). The successful membrane modification has been confirmed by FTIR analysis showing characteristic peaks of the methacrylate hydrogel and that of the COF-300 nanoparticles.

The separation performance of the modified membrane was measured. The pure water permeance was 68.6 L·m⁻²·h⁻¹·bar⁻¹. Further, the PFOA removal efficiency was determined by filtering the PFOA-spiked real groundwater sample. The groundwater sample was collected from a well near Yad Mordechai kibbutz (well Yad Mordechai-1), and its composition can be seen in Table 4. The groundwater was spiked with PFOA in a concentration of 500 ppb. The modified membrane removed 67.6% PFOA and 74.3% nitrate from the spiked real groundwater sample, with permeate flux of 52.9 L·m⁻²·h⁻¹ (at 2 bar).

TABLE 4
Composition of contaminated groundwater sample
collected from Yad Mordechai kibbutz.

| Parameter | Value | Unit |
|---|---|---|
| Nitrate | 70 | mg · L⁻¹ |
| Bicarbonate | 265 | mg · L⁻¹ |
| Boron | 0.2 | mg · L⁻¹ |
| Bromide | 0.6 | mg · L⁻¹ |
| Calcium | 78 | mg · L⁻¹ |
| Chloride | 150 | mg · L⁻¹ |
| Fluoride | 0.7 | mg · L⁻¹ |
| Potassium | 4.1 | mg · L⁻¹ |
| Sodium | 87 | mg · L⁻¹ |
| Sulphate | 43 | mg · L⁻¹ |
| DO | 8.1 | mg · L⁻¹ |
| EC | 1050 | μS · cm⁻¹ |
| pH | 7.5 | — |

### Cross-Linking Degree Evaluation

The inventors manufactured the herein disclosed coated membranes using 2.5 and 5 wt. % MBA crosslinker, in addition to the hydrophilic monomers during graft polymerization as a way of stabilizing the functional nanoparticles on the membrane surface without hampering its separation performance.

The antifouling property of the modified membrane was examined by measuring the flux after the filtration of the PFAS-contaminated water and subsequent washing with water, and the flux recovery ratio was 96%, indicating the excellent antifouling propensity of the modified membrane. The membrane stability was also examined by recording the FTIR spectrum of the used modified membrane and compared to the spectrum before filtration, and the comparison suggests that the spectra remained the same, indicating that the modification (COF-300/methacrylate hydrogel) layer remained intact after conducting the extensive filtration experiments. These results indicated the efficacy of our membrane modified by methacrylate hydrogel-stabilized COF-300 nanoparticle layer for the efficient removal of PFOA from the contaminated groundwater.

Additional examples of COF-300 nanoparticles deposited on PAN membrane (PAN RS50 membrane) have been prepared. PAN membranes with different surface densities of the nanoparticles on the membrane: 187, 93, and 23 μg/cm² have been successfully manufactured by the inventors. The COF nanoparticles have ˜0.5 μm length. In addition, the different surface densities resulted in similar top views of the top layer of the nanoparticles.

Results of Stabilizing Nanoparticles without Using a Crosslinker

To further justify the importance of using MBAA crosslinker in the grafting, we did initial experiments to stabilize a layer of ZIF-8 nanoparticles on the membrane surface without any crosslinker in the redox-initiated graft polymerization. The stability of the nanoparticle layer on the modified membrane was examined by performing the EDS elemental analysis on the fresh and used (after filtration experiments) membrane samples. It was found that the composition of zinc (a constituent of the ZIF-8 nanoparticles) reduced from 4-5 wt. % to less than 0.1 wt. %, indicating that the hydrogel (without crosslinker) was not suitable for stabilizing the nanoparticle layer on the membrane surface. It is worth noting that the composition of zinc in the membrane modified with the crosslinked hydrogel remained the same (4-5 wt. %) after extensive filtration experiments. Based on the above, the criticality of using the crosslinked polymer for the coating of the invention should be appreciated. It is postulated that the optimal crosslinking degree of the herein disclosed polymer is between 1 and 20%. Alternatively, a w/w ratio and/or a molar ratio between the polymer and the crosslinking agent, as disclosed herein is between 1 and 20%.

Additionally, the inventors successfully prepared various CFS on polymeric membranes, stabilized by the graft-co-polymer, as disclosed herein.

For example: ZIF-8 nanoparticles in-situ grown on a PAN membrane with molecular weight cut-off value of 325.4 kDa; ZIF-67 nanoparticles in-situ grown on a PAN membrane with molecular weight cut-off value of 105 kDa; Co/Zn based ZIF-L nanoparticles (with a particle size between 1 and about 10 μm) in-situ grown on a PAN membrane with molecular weight cut-off value of 105 kDa; Zn based ZIF-L particles (with a particle size between 1 and about 5 μm) in-situ grown on a Polyethersulfone (PES) membrane with molecular weight cut-off value of 75 kDa; and ZIF-8 nanoparticles in-situ grown on a PES membrane with molecular weight cut-off value of 50 kDa have been successfully prepared and stabilized by the graft-co-polymer, as disclosed herein.

### Example 4

### Ultrafiltration Water Treatment Membranes

### Materials

Nanofiltration (NF90 and NF200) and polyacrylonitrile (PAN) ultrafiltration flat-sheet membranes were provided by DuPont FilmTec Co. (Midland, MI, USA) and RisingSun Membrane Technology (Beijing, China), respectively. Tris(hydroxymethyl)aminomethane (Tris buffer, 99.8%) was purchased from Acros Organics Co. (St. Janssen-Pharmaceuticalaan 3a, B-2440 Geel, Belgium). Dopamine hydrochloride (99%) and 2,2,3,4,4,4-hexa-fluorobutyl methacrylate fluorinated monomers were obtained from Thermo Fisher Scientific (St. Shore, Lancashire, UK). [2-(Methacryloyloxy)ethyl]dimethyl-(3-sulfopropyl)ammonium hydroxide (SBMA, 95%), N, N′-methylenebis(acrylamide) (MBA, 99%), and cobalt (II) nitrate hexahydrate (98%) were obtained from Sigma-Aldrich Chemical Co. (St. Louis, MO, USA). 2-Methylimidazole (2-MIM, 98%) was purchase from Tokyo Chemical Industry (Tokyo, Japan). All chemicals used in the study were not further purified.

Hexane, absolute ethanol, absolute methanol, and isopropanol (IPA) were purchased from Bio-Lab Ltd. (Jerusalem, Israel). Photoinitiator benzophenone (BP, 99%), and bovine serum albumin (98%) foulant were obtained from Sigma-Aldrich Chemical Co. (St. Louis, MO, USA). Potassium hydroxide flakes was purchased form Bio-Lab Ltd. (Jerusalem, Israel).

Barium chloride dihydrate (99%), potassium nitrate (99%), calcium chloride dihydrate (99%), iron (III) nitrate nonahydrate (98%), zinc sulfate heptahydrate (ZnSO₄·7H₂O), sodium fluoride (99%), and sodium tetraborate (99%) were purcchase from Sigma-Aldrich Chemical Co. (St. Louis, MO, USA). Sodium chloride (98%) and anhydrous magnesium sulfate (99%) were purchase from Bio-Lab Ltd. (Jerusalem, Israel) and Carlo Erba Reagents Co. (Sabadell, Barcelona, Spain), respectively. Deionized (DI) water was used in all experiments unless otherwise stated.

### Modification of PAN UF Composite Membrane by Hydrogel-Stabilized MOF

Hydrolysis of the PAN Membrane. The pristine PAN membrane of 0.00541 m² surface area was washed overnight with water and then hydrolyzed with 1 M KOH aqueous solution at 60° C. for 1 h at 300 rpm. The membranes were subsequently rinsed with deionized water for up to 14 days to neutralize the solution's pH. The resulting membrane was named Hy membrane.

In-situ Formation of a ZIF-67 Nanoparticle Layer on the Hy Membrane. Co(NO₃)₂·6H₂O aqueous solution (0.44 g in 30 mL) was prepared and incubated with the Hy membrane for 12 h at 25° C. under continuous shaking at 85 rpm. The Co(NO₃)₂·6H₂O aqueous solution was then discarded, and the membrane was washed with DI water for 1 min with shaking. Then, the membrane was incubated with 2-methylimidazole (2-MIM) organic linker aqueous solution (0.974 g in 30 mL) for 9 h with continuous shaking at 85 rpm. 2-MIM solution was discarded, and the membrane was washed three times under running DI water. The Hy membrane with in situ grown ZIF-67 nanoparticles was named HyZIF67.

Graft Polymerization Using Zwitterionic Methacrylate Monomer. Hy and HyZIF67 membranes were surface-modified by graft polymerization using UV irradiation for 5, 7.5, and 10 min. The membranes were first incubated with BP photoinitiator (0.05 M and 0.1 M in 80% ethanol/water solution of 30 mL) for 10 min and 30 min. The BP solution was then discarded, and the membrane surface was washed with water for 1 min with shaking at 85 rpm to remove residual BP. Afterwards, the membranes were incubated with 0.8 M SBMA solution containing 0.04 M MBA crosslinker in 30 mL aqueous solution with shaking. The incubation time of SBMA/MBA solution on the membrane surface was 30 seconds at 25° C. prior to UV grafting. The process was kept in dark conditions to avoid UV activation prior to the irradiation. The membranes were then UV irradiated for 5, 7.5 and 10 min, by 50% UV light intensity. The grafted membranes were taken out and immediately rinsed with DI water to remove any unreacted and non-grafted SBMA monomers and chains from the membrane surfaces. The SBMA-co-MBA-grafted Hy and HyZIF67 membranes were named HyG and HyZIF67G membranes, respectively, and were stored in DI water overnight for further evaluation and analysis.

Inductively Coupled Plasma-Optical Emission Spectrometer Analysis An inductively coupled plasma-optical emission spectrometer (ICP-OES; SPECTRO ARCOS, AMETEK, Inc., USA) was used to determine the elemental composition of a sample by measuring the emission spectra when a solution is introduced to plasma. The method uses argon, air, and nitrogen gases for its operation. ICP-OES was operated to determine the concentration of Co, a constituent element of ZIF-67 nanoparticles, in the feed and permeate solution 15 min after the start of filtration experiments. At least two measurements from the feed and permeate of the HyZIF67G membranes were taken for analysis, and the average value was presented in this study.

Atomic Force Microscopy The surface roughness of the membranes was measured by atomic force microscopy (AFM) in QI™ mode with a NanoWizard 4 microscope (JPK Instruments, Bruker Nano GmbH, Berlin, Germany). AFM was operated in both air and a wet atmosphere in the tapping mode. The root mean square (RMS) roughness values in a 5 μm×5 μm area of the membrane surfaces were calculated for at least three different areas of each membrane. RMS roughness values were reported as mean±standard deviation (S.D.).

Bradford Protein Assay The Bradford protein assay was performed by using Quick Start Bradford Dye Reagent Concentrate (Bio-Rad Laboratories GmbH, Feldkirchen, Germany) for protein quantification. BSA solution of 100 mg·L⁻¹ was filtered through the modified membrane for 1 h. 10 mL of the BSA-water solution from the feed and the permeate were collected after filtration. The absorbance of BSA present in both the feed and permeate of at least 5 samples was measured using a UV-Vis. Spectrophotometer (Infinite M200 plate reader, Tecan, Australia) at 595 nm. Each sample preparation followed the low BSA profile concentration protocol, in which 800 μL of the sample was first vortexed for a few seconds with 200 μL Bradford reagent, and after 5 min, the samples were placed in a costar 48 flat transparent plate for absorbance measurements. The calibration curve of BSA absorbance was plotted for BSA concentrations of 1, 5, 10, and 15 mg·L⁻¹.

Pure Water Permeance Measurements The pure water permeance (PWP) of NF and PAN membranes was evaluated using a stainless-steel dead end-cell filtration setup containing a single membrane with an effective area of 0.00134 m² (4.13 cm in diameter). The schematic diagram of the experimental filtration setup is shown in FIG. 1.

Evaluation of PWP of PAN membranes. The same dead-end filtration setup was used for PAN membranes. The PWP measurements were obtained after gaining a steady water flux at 2 bars after 12 h compaction time. Water permeance was collected in constant intervals of 15 min for over 1 h, and the measured values were recorded for each membrane. The membranes' PWP were calculated using Equation (3.1).

BSA foulant was selected in this study as a model foulant to examine the membrane performance. The antifouling properties of the membranes were evaluated using the same dead-end filtration setup described herein. Three types of fouling solutions were created by dissolving 100 mg·L⁻¹ BSA foulant in the following background solutions: 1) water, 2) 20 mM NaCl, and 3) synthetic secondary wastewater (SSWW). SSWW solution was prepared based on the composition of real secondary effluent wastewater in the Shafdan Wastewater Treatment Plant in Israel during July-August, 2015 and is depicted in Table 5. Initially, pristine PAN and modified membranes were compacted at 2 bars to obtain a steady-state flux with one of the three background solutions for 1-2 h. The filtration experiment was initiated by obtaining a steady permeate flux (J₀) of ˜100 L·m⁻²·h⁻¹, J₀ was recorded in continuous intervals of 3 min for 30 min for each membrane with each of the background solution.

Next, the fouling experiments were performed using BSA/DI water (pH˜5.85), BSA/NaCl (pH˜6.55) or BSA/SSWW (pH˜6.76 and pH˜7.43) solutions separately for PAN, HyG and HyZIF67G membranes. Each fouling solution was filtered and the flux (Jₜ) was recorded every 3 min interval for 1 h. After 1 h of filtration, the fouled membranes were cleaned using DI water without any applied pressure for 15 min with stirring. Finally, a background solution was introduced and the flux of the washed membrane (J_{c}) was measured for 30 min for every 3 min intervals. Membrane permeate flux in L·m⁻²·h⁻¹ unit was calculated using Equation (3.3),

$$Permeate Flux = \frac{V}{( t \times A )} \qquad ( 3.3 )$$

where V is the permeate volume (grams), A is the effective surface area of the membrane (m²), and t is the filtration interval duration (h).

To evaluate the antifouling properties of PAN modified membranes, the flux recovery ratio was measured using Equation (3.4),

$$FRR \% = ( \frac{{J}_{c}}{{J}_{0}} ) \times 100 \qquad ( 3.4 )$$

where J₀ (L·m⁻²·h⁻¹) is the permeate flux before membrane fouling and J, (L·m⁻²·h⁻¹) is the permeate flux after washing the fouled membrane.

Preparation of synthetic secondary wastewater effluent. A synthetic solution simulating the chemistry of secondary-treated effluents of the Shafdan Wastewater Treatment Plant in the Tel Aviv region, Israel was prepared. The composition of the SSWW can be found in Table 3.1. After dissolving the relevant salts, the prepared solution was stirred for at least 6 h prior to BSA introduction for fouling experiments.

TABLE 5
Composition of the synthetic secondary
wastewater (SSWW) effluent solution.

| Parameters | Units | Values |
|---|---|---|
| pH | — | 6.4-7.9 |
| Conductivity | μS · cm⁻¹ | 1650 |
| F⁻ | mg · L⁻¹ | 0.54 |
| Cl⁻ | mg · L⁻¹ | 314 |
| B³⁺ | mg · L⁻¹ | 0.3 |
| Zn²⁺ | mg · L⁻¹ | 0.051 |
| Fe³⁺ | mg · L⁻¹ | 0.074 |
| Mg²⁺ | mg · L⁻¹ | 32 |
| SO₄²⁻ | mg · L⁻¹ | 90 |
| K⁺ | mg · L⁻¹ | 19.3 |
| Ca²⁺ | mg · L⁻¹ | 85 |
| Na⁺ | mg · L⁻¹ | 203 |
| NO³⁻ | mg · L⁻¹ | 6.17 |
| Ba²⁺ | mg · L⁻¹ | 0.11 |

### Hydrogel-Stabilized Zeolitic Imidazole Framework-67 Nanoparticles on PAN Ultrafiltration Membrane

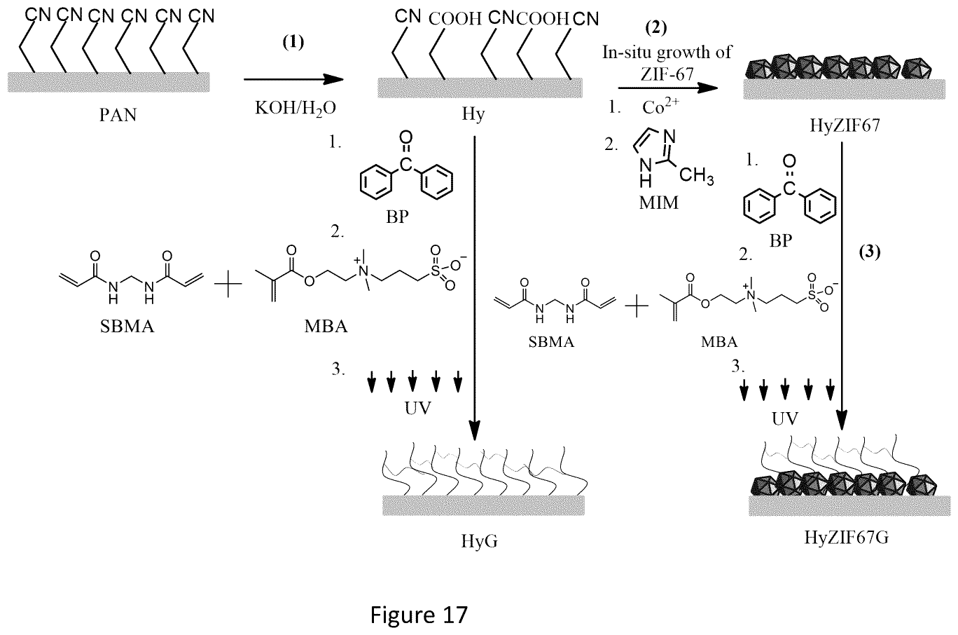

Porous PAN membrane was chosen for stabilizing the in situ grown ZIF-67 nanoparticles via UV-graft polymerization of a methacrylate hydrogel layer to improve the antifouling property of the membrane. PAN membrane was hydrolyzed by KOH solution resulting in carboxyl groups on the membrane surface (named Hy membrane). Hy membrane was used as a substrate for grafting in situ ZIF-67 nanoparticles (named HyZIF67). HyZIF67 membrane surface was further modified by SBMA methacrylate monomer using the UV-graft polymerization technique; the resulting membrane was named HyZIF67G. The preparation of stabilized ZIF-67 nanoparticles on PAN membranes by UV-grafting of zwitterionic methacrylate hydrogel monomer is shown in FIG. 17. UV grafting of Hy membrane by the same monomer was performed as a reference membrane to obtain HyG membrane (FIG. 17).

Four variations of the membrane modification were established throughout the study and compared. Each protocol was set to optimize specific parameters, such as BP initiator concentration, UV irradiation time, and BP incubation time. In the 1^{st} and 2^{nd} protocols, UV irradiation time was maintained at 5 min and 10 min, respectively, while keeping BP photoinitiator concentration (0.05 M) and BP incubation time (10 min.) constant. In protocol 3 and 4, the BP incubation time was set to 10 min and 30 min, respectively, while keeping the BP photoinitiator concentration (0.1 M) and UV irradiation time (10 min) constant. The 1-4 protocols are described in Table 6.

TABLE 6
Major parameters used in the preparation process of
UV grafting of SBMA monomer on the modified HyZIF67
membranes in the coupling with BP concentrations,
BP incubation times and UV irradiation time.

| | UV grafting conditions | | |
|---|---|---|---|
| Protocol | BP Concentration | BP incubation time | Irradiation time |
| 1^{st} | 0.05M | 10 min | 5 min |
| 2^{nd} | 0.05M | 10 min | 10 min |
| 3^{rd} | 0.1M | 10 min | 10 min |
| 4^{th} | 0.1M | 30 min | 10 min |

To confirm the synthesis and the formation of ZIF-67 nanoparticles on the surface of PAN membranes and the UV grafting of the methacrylate co-polymer on modified membranes, FTIR, EDX, XRD, WCA, SEM, and AFM analyses were carried out. More specifically, the membrane surface functional groups were confirmed by FTIR, and the presence of the characteristic elements and the membrane surface crystallinity were studied using EDX and XRD, respectively. The water contact angle analysis gave insight one membrane hydrophilicity properties, while the surface morphology and roughness of the synthesized nanoparticles and modified membranes were characterized by SEM and AFM analyses, respectively.

The presence of the organic functional groups on the surfaces of pristine PAN and modified membranes was investigated by ATR-FTIR spectroscopy. In the pristine PAN membrane, the peaks at 1452 cm⁻¹ and 2240 cm⁻¹ are attributed to the nitrile stretching vibrations of —C≡N^{71, 72, 73} and the peak at 1741 cm⁻¹ is associated with the carbonyl group (C═O) stretching, which may result from carboxylic acids or esters due to additives used during the fabrication of the commercial PAN membrane.

Hydrolysis of PAN membranes was performed with KOH alkaline solution; the FTIR spectrum of Hy membrane showed the conversion of the surface nitrile groups to carboxylic groups, which was associated with the appearance of new peaks at 1729 cm⁻¹ and 1672 cm⁻¹. An additional peak appeared at 1563 cm⁻¹ (as a shoulder), which could be correlated to the NH group in carboxamide (resulting from the conversion of —CN groups into —CONH₂ groups by the alkaline hydrolysis of the PAN membrane). The spectra of hydrolyzed PAN membrane provided strong evidence of a successful transformation of —CN to COOH and CONH₂ groups during the alkaline hydrolysis process.

The FTIR spectrum of HyG membrane detected peaks at 1042 cm⁻¹ and 1181 cm⁻¹, which are assigned to the symmetric and asymmetric vibrations of the sulfonate groups (—SO₃—) of SBMA UV-grafted polymer on Hy membrane, respectively. Additionally, the appearance of the peaks in 1668 cm⁻¹ and 1727 cm⁻¹ was likely associated with the amide and ester vibrations of C═O. Notably, peaks at 956 cm⁻¹ and 1448 cm⁻¹ are the characteristic peaks of C—N stretching vibration of the quaternary ammonium group. The appearance of these peaks confirms the successful grafting of poly(SBMA-co-MBA) polymer on the Hy membrane.

The membrane with in-situ grown ZIF-67 nanoparticles (HyZIF67) showed new peaks at 995 cm⁻¹, 1143 cm⁻¹, and 1304 cm⁻¹, that are attributed to the stretching and bending of the 2-methylimidazole ligand of ZIF-67 nanoparticles. More specifically, the peaks at 995 cm⁻¹ and 1143 cm⁻¹ could be assigned to C—N bending vibrations, and the peak at 1304 cm⁻¹ may be attributed to the aromatic stretching mode for the entire ring of imidazole.

Finally, the FTIR spectrum of the HyZIF67G membrane confirmed the grafting of poly(SBMA-co-MBA) on the membrane coated with ZIF-67 nanoparticles. The HyZIF67G spectrum exhibited the characteristic peaks of both the ZIF-67 nanoparticles and methacrylate polymer, as compared with the FTIR spectra of HyZIF67 and HyG membranes. To confirm the presence of ZIF-67 nanoparticles on the membrane surface, the FTIR spectra of both the PAN and HyZIF67 membranes were recorded for the wavenumber between 400 cm⁻¹ and 600 cm⁻¹. The FTIR spectrum shows a characteristic peak at 426 cm⁻¹ attributed to the Co—N stretching vibration of the ZIF-67 nanoparticles on the membrane surface, which confirms that the ZIF-67 nanoparticles are present on the HyZIF67 membrane.

### Elemental Composition by Energy Dispersive X-Ray Spectroscopy

The membranes' surfaces were also analyzed using EDX spectroscopy (Table 7). Compared to pristine PAN membranes, the hydrolyzed membrane showed an increase in oxygen content, which was in accordance with the carboxyl groups obtained by the hydrolysis of the nitrile groups in PAN membranes.

The existence of sulfur on the surface of HyG membrane and an increase in the oxygen content compares to Hy membrane resulted from the sulfonate groups of SBMA and its high oxygen content, respectively, implying successful UV grafting of the methacrylate SBMA polymer on the Hy membrane.

Co²⁺ appeared on the HyZIF67 membrane and was accompanied by a decrease in oxygen content and an increase in nitrogen content, indicating the presence of ZIF-67 nanoparticles on the HyZIF67 membrane surface.

The EDX analysis of the HyZIF67G membrane showed the presence of both sulfur and cobalt, which are derived from the methacrylate SBMA grafting polymer and ZIF-67 nanoparticles, respectively. Therefore, the EDX results further support successful membrane modification according to FIG. 17.

TABLE 7
EDX analysis of the surface of pristine and
modified membranes in mass percentage.

| Membrane | C, % | O, % | N, % | S, % | Co, % |
|---|---|---|---|---|---|
| PAN | 80.47 | 4.9 | 14.63 | N.d. | N.d. |
| Hy | 76.35 | 7.43 | 16.22 | N.d. | N.d. |
| HyG | 62.91 | 17.34 | 14.50 | 5.25 | N.d. |
| HyZIF67 | 59.89 | 4.29 | 29.69 | N.d. | 6.13 |
| HyZIF67G | 62.25 | 16.79 | 13.13 | 3.82 | 1.02 |

### Membrane Analysis by X-Ray Diffraction

XRD spectra of PAN, Hy, HyG, HyZIF67 and HyZIF67G are shown in FIG. 4.5. The set of the diffraction planes (001, 005, and 111) of the pristine PAN membrane have three dominant peaks at 2θ of 17.6°, 22.8°, and 25.9°, respectively, which were attributed to the crystallinity structure of the PAN. More specifically, the plane (001) has characteristics in a hexagonal structured PAN, and the (005) and (111) planes are assigned to the crystallinity of the polymer chains of PAN. The characteristic peaks of the ZIF-67 nanoparticles appeared at 2θ=7.34°, 10.32°, 12.6°, 14.63° and 16.48° corresponding to (0 1 1), (0 0 2), (1 1 2), (0 2 2), and (0 1 3) reflections. The appearance of these peaks indicates successful synthesis and attachment of ZIF-67 nanoparticles to the membrane surface, as confirmed by XRD showing patterns of the synthesized ZIF-67 crystals after surface modifications.

### Wettability of the Pristine and Modified Membranes

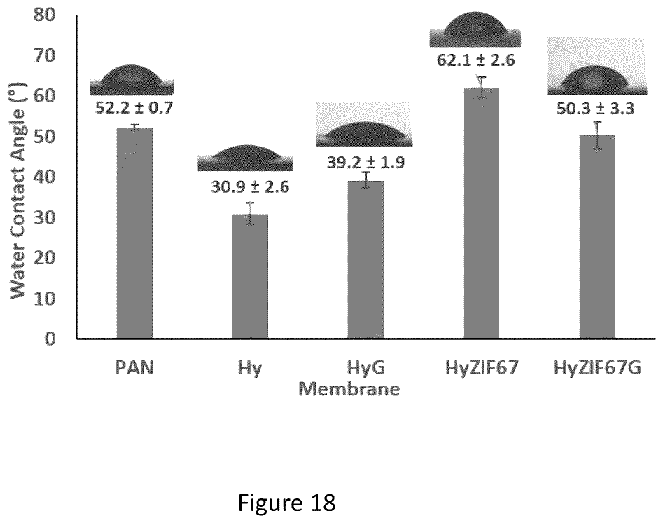

The effect of the different membrane modifications on membrane surface wettability was assessed with water contact angle measurements. Sessile water-drop contact angles of the PAN, Hy, HyG, HyZIF67 and HyZIF67G membranes were measured as shown in FIG. 18. The Hy membrane showed a reduction in water contact angle from 52.2°±0.7° of pristine PAN to 30.9°±2.6° upon hydrolysis. The increasing surface hydrophilicity can be attributed to a high concentration of carboxyl groups on the membrane surface.

HyG membrane exhibited a water contact angle of 39.2°±1.9° which was higher than that for the Hy membrane (30.9°±2.6°) but substantially lower than that of pristine PAN. This was attributed to the existence of the hydrophilic grafted hydrogel, which contains sulfonate groups of the zwitterionic SBMA polymer. This thus indicates successful UV grafting of the methacrylate polymer. The properties of both Hy and HyG membranes implied the improvement of membrane surface hydrophilicity.

The water contact angle of the HyZIF67 membrane increased to 62.10±2.6° due to the incorporation of hydrophobic ZIF-67 nanoparticles on the membrane surface. The ZIF-67 nanoparticles also increase the surface roughness, which contributed to the increased water contact angle. On the other hand, the HyZIF67G membrane exhibited a contact angle of 50.3°±3.3°, which is lower (and thus more wettable) than the HyZIF67 membrane, supporting successful coating of ZIF67 nanoparticles by the zwitterionic hydrophilic hydrogel.

### Surface Morphology

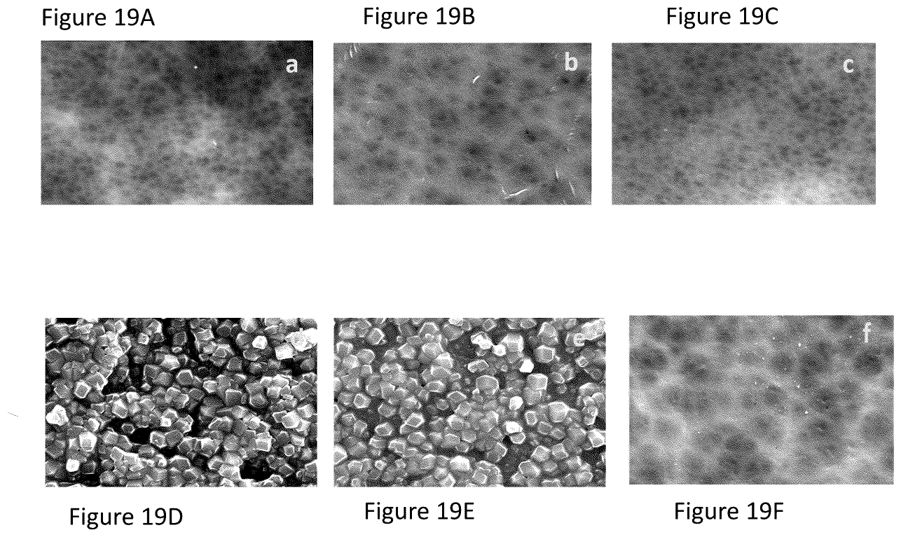

FIGS. 19A-F depict SEM images of the top surfaces of pristine PAN, Hy and HyG membranes. It can be seen that all the surfaces exhibit a smooth surface morphology. FIGS. 19D-E show the surface morphology of the in situ grown ZIF-67 nanoparticles on two different HyZIF67 membranes, where a layer of ZIF-67 nanoparticles cohesively cover the surface. The size of the in situ grown ZIF-67 nanoparticles is around 1 μm as confirmed by SEM analysis. The SEM image of the ZIF-67 nanoparticles layer coated by UV-graft polymerization of methacrylate SBMA hydrogel (HyZIF67G membrane, FIG. 19F) shows full coverage of ZIF-67 nanoparticles by the methacrylate hydrogel.

### Surface Roughness by Atomic Force Microscopy Analysis

For further insight into the surface morphology, we performed AFM analysis of roughness of the pristine and modified membranes. The Rᵣₘₛ value was estimated based on AFM images of at least two readings from each modification, where the scanning area for each membrane was set to 5×5 in. All of the AFM analyses were conducted in water (wet conditions), except for the HyZIF67 membrane where the analysis was performed in dry conditions. The importance of surface roughness comes from its correlation with the fouling behavior of the membranes and its influence on the separation performance. The surface roughness of pristine PAN and Hy membrane were measured, and their Rᵣₘₛ values were 24.5±1.8 nm and 18.7±0.9 nm, respectively. The Hy membrane exhibited a smoother surface compared to the PAN. The HyG membrane showed a smooth roughness with an Rᵣₘₛ value of 20.2±1.8 nm, slightly higher than the Hy membrane.

In contrast, much higher roughness was determined for the HyZIF67 membrane compared to the Hy membrane. MOF were deposited onto the surface and the roughness was further increased to 91.8±0.9 nm. However, the HyZIF67G membrane showed a decrease in the surface roughness with 51.9±3 7 nm compared to the HyZIF67, emphasizing the impact of the presence of the methacrylate hydrogel layer. The surface roughness of HyZIF67 and HyZIF67G membranes showed that HyZIF67G gained combined characteristics from the grafted methacrylate layer and ZIF-67 formation.

### Separation Performance of Modified Membranes

The separation performances of the HyG membrane and an exemplary HyZIF67G [0323] membrane of the invention were investigated by measuring their water permeance and antifouling properties using a simulated municipal wastewater solution. The pure water permeance of HyG membrane showed a high PWP of 311.8±5.9 L·m⁻²·h⁻¹bar⁻¹. The stabilized HyZIF67G membrane exhibited a slight decrease showing a PWP of 205.4±3.7 L·m⁻²·h⁻¹·bar⁻¹.

Additionally, analysis of cobalt in the permeate was performed to examine the stability of the ZIF-67 nanoparticles on the modified HyZIF67G membrane. The cobalt ion concentrations in the feed and permeate during PWP filtration experiments of HyZIF67G membrane were determined by ICP analysis. Our findings showed that the cobalt concentration in the feed was below the detection limit of the ICP, and the concentration of Co²⁺ in the permeate was very low: 82 ppb. The low concentrations of cobalt indicated a good stability of the ZIF-67 nanoparticle layer on the grafted HyZIF67G membrane surface.

### Antifouling Properties of Modified Membranes During Filtration of Secondary-Treated Municipal Wastewater

Secondary treated municipal wastewater effluents contain high organic matter loads which severely affect the environment. Further, its treatment using membrane technology causes severe organic fouling problems. To study the membrane treatment of secondary wastewater, in our study, we simulated a synthetic secondary wastewater solution with organic foulant to mimic the real wastewater effluent. The antifouling experiments were performed by filtering a BSA-laden SSWW solution through the membranes using a dead-end filtration cell. The composition of the simulated SSWW solution has been described above. Antifouling experiments were performed by filtering BSA solution in DI water, BSA in 20 mM NaCl solution (the same ionic strength as SSWW), and BSA in the SSWW solution.

The filtration was tested for the pristine PAN membrane and HyZIF67G membranes. Initially the filtration of BSA in water was tested; BSA aqueous solution of 100 mg·L¹ was introduced as feed solution where one filtration experiment lasted for 2 h, followed by 15 min washing using DI water with stirring and without applying pressure. Upon contact with the BSA solution, PAN membrane exhibited a severe decline in permeate flux while the HyZIF67G membranes experienced a comparatively lower decline in permeate flux.

Additional antifouling experiments have been performed by filtering BSA in 20 mM NaCl solution through PAN and HyZIF67G membranes. Similarly, after filtration of 20 mM NaCl solution mixed with 100 ppm BSA, the PAN membrane exhibited a severe decline in permeate flux while the HyZIF67G membrane exhibited improved antifouling performance and lower decline in permeate flux compared to the pristine PAN membrane. In conclusion, in terms of final flux and antifouling performance, the HyZIF67G membrane prepared by the 3rd protocol (Table 6) showed superior performance with FRR of 99.5% compared to the pristine membrane. Furthermore, HyZIF67G membranes prepared according to protocols 1, 2 and 4 have been compared the HyZIF67G membrane prepared by the 3rd protocol (Table 6), resulting a comparable performance with FRR ranging between about 90 to about 99%.

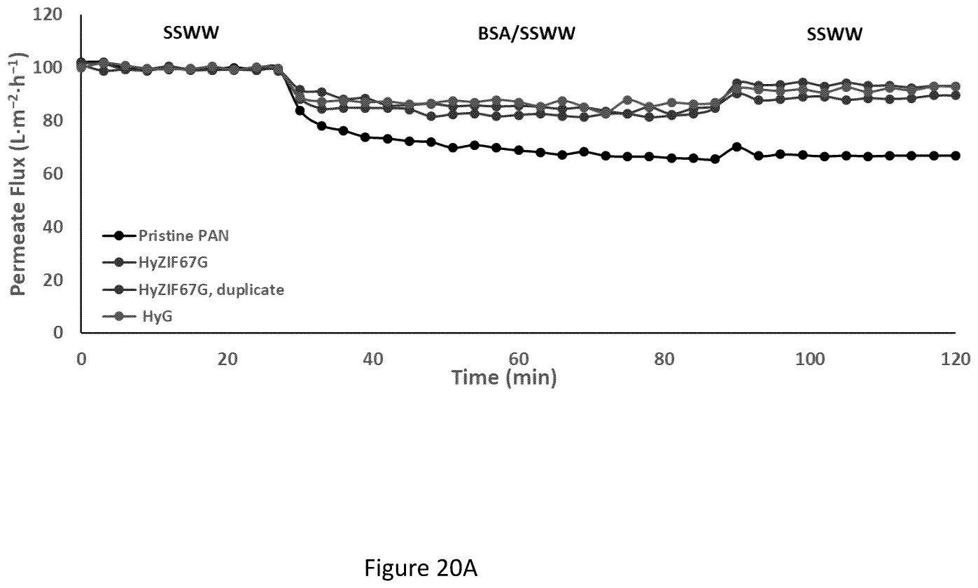

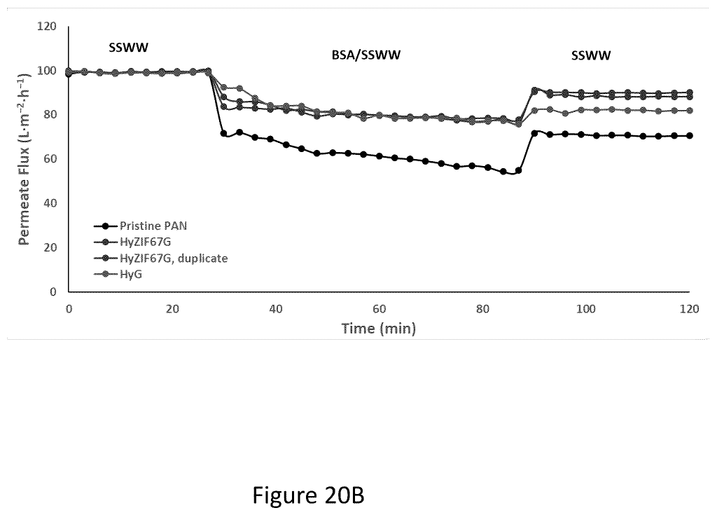

To evaluate BSA antifouling performance of the modified membranes while filtering SSWW effluent (Table 5), the permeate flux of PAN, HyG and HyZIF67G membranes was examined and measured during the filtration of 100 ppm BSA foulant in SSWW solution at a pH 6-7. FIG. 20A shows that both the HyG and HyZIF67G membranes displayed an improvement in fouling resistance when filtering BSA/SSWW solution, as these membranes (I) lowered the rate of initial flux decline; and (II) increased the value of steady flux at the end of the fouling run, compared with the pristine unmodified membrane. Although the HyZIF67G and HyG membranes showed similar antifouling performance, the HyG membrane exhibited 15% less PWP compared to the HyZIF67G membrane, indicating that the HyZIF67G membrane exhibited the best performance in terms of overall transport properties and antifouling performance. The antifouling performances of the PAN, HyG and HyZIF67G membranes at a pH of 7.15-7.7 is presented in FIG. 20B.

The BSA rejection value of the HyZIF67G membrane (3^{rd} protocol) was measured using Bradford assay analysis. The BSA solution concentrations in the feed and permeate after filtration were 100 mg·L⁻¹ and 3.334 mg·L⁻¹, respectively. Based on Equation (4.1), the BSA rejection of the HyZIF67G membrane was 96.7%.

$$Rejection ( \% ) = ( 1 - \frac{{C}_{p}}{Cf} ) \times 100 \qquad ( 4.1 )$$

where C_{P} and C_{F} represent the concentrations of BSA in the permeate and feed solutions, respectively.

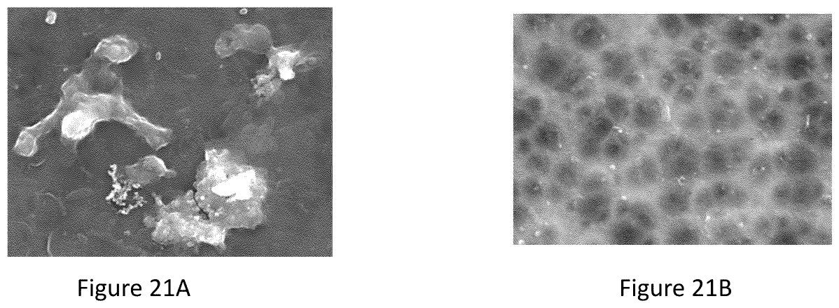

The surface morphologies of the membranes after BSA/SSWW antifouling filtration experiments were examined using SEM which indicated different membrane surface morphologies; the SEM micrographs (FIGS. 21A-B) showed several aggregates on the surface of the PAN, Hy, and HyG membranes. There was a severe attachment of foulants on the surface of the pristine PAN membrane. On other hand, the attachment of the foulants was negligible for the HyZIF67G membrane, confirming its excellent antifouling performance.

### Long-Term Antifouling Properties of HyZIF67G Membrane for Secondary Municipal Wastewater Treatment

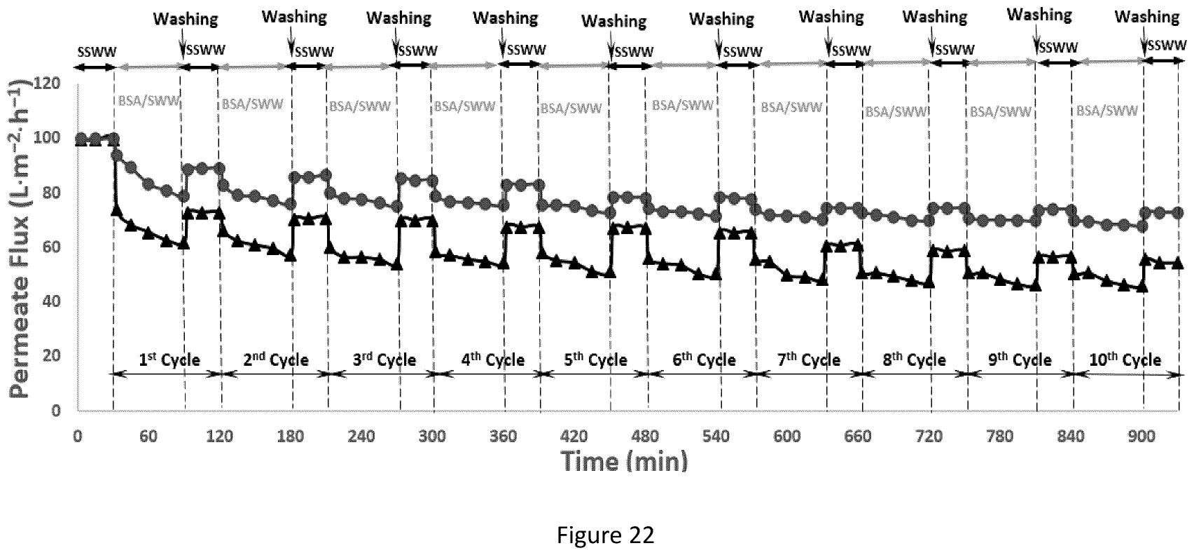

The dead-end configuration of the experimental cell was used for long-term antifouling performance experiments; the permeate flux of PAN and HyZIF67G membranes were tested in long-term BSA filtration experiments in SSWW solution (Table 5). A total of 10 cycles of fouling experiments were performed where the duration of each cycle filtration is 2 h. Before starting the filtration cycles, the permeate flux was calibrated to 100 L·m⁻²·h⁻¹ using SSWW as feed and filtration for an additional 0.5 h while measuring the permeance. Then, each cycle started with filtration of SSWW solution with 100 ppm BSA while recording the flux permeance each 3 min for 1 h. Afterwards, BSA/SSWW solution was discarded, and the fouled membrane underwent 15 min-long washing using DI water with stirring but without applying pressure. Then, SSWW solution was filtered for 15 min and for an additional 0.5 h with flux measurements (FIG. 22).

Based on FIG. 22, the pristine PAN membrane exhibited severe flux decline after 10 cycles of filtration of BSA-laden SSWW foulant solution; the measurements showed that the flux recovery ratio of PAN was 57.4% compared to the 73.2% flux recovery ratio for the HyZIF67G membrane. This further indicated the impact of surface functionalization of grafting SBMA incorporated with ZIF-67 nanoparticles on the fouling propensity of the membranes.

After 10 filtration cycles of synthetic secondary wastewater effluents spiked with bovine serum albumin, the HyZIF67G membrane exhibited improved antifouling characteristics with a 73.2% flux recovery ratio value compared to the 57.4% ratio for the pristine membrane.

After each filtration cycle, it was observed that the hydraulic washing removed the reversible fouling, while the irreversible fouling accumulated on the membrane surfaces leading to the decline in membrane performance. The steady-state flux with a higher permeate value for HyZIF67G membrane (73 L·m⁻²h⁻¹) after 10-cycle filtration experiments compared to the pristine membrane (54 L·m⁻²·h⁻¹) further suggested that the affinity between the BSA foulant and HyZIF67G membrane surface was the lowest and could provide desirable antifouling performance.

Compared to the commercial membranes, the HyZIF67G membrane of the invention showed high performance in general with a good PWP (47.6 L·m⁻²h⁻¹·bar¹) at 2 bar and a high flux recovery ratio (89%) using SSWW solution, indicating that the addition of ZIF-67 nanoparticles on the HyG membrane displays outstanding antifouling performance during wastewater treatment.

To this end, an exemplary membrane of the invention (HyZIF67G), was characterized by FTIR, EDX and XRD, which confirmed the presence of ZIF-67 nanoparticles and the zwitterionic methacrylate hydrogel on the membrane surface. The HyZIF67G membrane showed higher hydrophilicity compared to the pristine PAN membrane.

After 10 filtration cycles of synthetic secondary wastewater effluents spiked with bovine serum albumin, the HyZIF67G membrane exhibited improved antifouling characteristics: The flux recovery ratio value after ten filtration cycles was 73.2%, much higher than the pristine membrane with 57.4%. Further, the BSA rejection of the HyZIF67G membrane was ˜97%. The SEM images of the fouled membranes showed that the HyZIF67G membrane experienced negligible attachment of foulants on its surface after filtration compared to the modified membrane without ZIF-67 nanoparticles or with PAN membrane, which illustrates the excellent antifouling properties of the HyZIF67G membrane.

Accordingly, the membranes disclosed herein can potentially be used in efficient UF filtration in water treatment applications such as treatment of reclaimed secondary municipal wastewater effluents, oil/water separation, whey protein concentration, and dye/salt separation.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A membrane comprising a polymeric membrane in contact with a coating layer comprising a plurality of crystalline framework structures (CFS) and a hydrogel comprising a cross-linked hydrophilic polymer; said membrane is water permeable; wherein the cross-linked hydrophilic polymer is grafted to an outer surface of said polymeric membrane.

2. The membrane of claim 1, wherein said cross-linked hydrophilic polymer is a zwitterionic polymer selected from a polyacrylate or a polymethacrylate.

3. The membrane of claim 1, wherein said CFS comprise nanoparticles; optionally wherein said nanoparticles are selected from covalent organic frameworks (COF) nanoparticles and metal-organic frameworks (MOF) nanoparticles.

4. (canceled)

5. The membrane of claim 1, wherein the outer surface of the polymeric membrane is chemically modified by a plurality of surface groups selected from amino and carboxy.

6. (canceled)

7. The membrane of claim 1, wherein said polymethacrylate comprises poly (2-(N-3-Sulfopropyl-N,N-dimethyl ammonium)ethyl methacrylate).

8. The membrane of claim 1, wherein said cross-linked hydrophilic polymer is characterized by a cross-linking degree of about 5%.

9. The membrane of claim 1, is characterized by any one of: (i) a water contact angle of about 7°, (ii) a water contact angle of about 21°, (iii) a water contact angle of less than 51°, (iv) a water contact angle being less than a water contact angle of a pristine polymeric membrane; optionally wherein said membrane is characterized by a water contact angle being about 13% less than a water contact angle of a pristine polymeric membrane.

10. (canceled)

11. The membrane of claim 1, characterized by any one of: pure water flow at a flux of about 450 L*m⁻²h⁻¹bar⁻¹; flux recovery ratio of at about 99% or any combination thereof; and wherein said polymeric membrane is selected from an ultrafiltration membrane, a nanofiltration membrane, and a microfiltration membrane.

12. (canceled)

13. A coated substrate comprising: a polymeric substrate in contact with a coating comprising a plurality of particles and a cross-linked polymer; wherein:
said cross-linked polymer is a hydrophilic polymer comprising an acrylate-based polymer;
an outer surface of said coating is characterized by a water contact angle of less than about 70°;
said cross-linked polymer is characterized by a cross-linking degree between 1 and 20%;
said plurality of particles is characterized an average particle size between 1 nm and 20 μm;
said coated substrate is water permeable.

14. The coated substrate of claim 13, wherein said cross-linked polymer is in a form of a matrix, and wherein said plurality of particles is embedded within said matrix; and wherein said cross-linked polymer is grafted to the polymeric substrate and is characterized by a cross-linking degree between 2 and 10%.

15. (canceled)

16. The coated substrate of any one of claim 1, wherein said polymeric substrate is in a form of a porous water permeable film characterized by a porosity sufficient to support pure water flow at a flux of at least 10 L·m⁻²h⁻¹bar⁻¹ and by an average pore size between 1 and 10 μm.

17. (canceled)

18. (canceled)

19. The coated substrate of claim 13, wherein said coating is in a form of a continuous layer characterized by a dry thickness between 50 nm and 20 μm; and wherein the outer surface of said coating is characterized by a negative zeta potential and optionally by a surface roughness of between 10 and 40 nm.

20. (canceled)

21. (canceled)

22. The coated substrate of claim 13, wherein a weight per weight (w/w) ratio between said particles and said cross-linked polymer within the coating is between 1:10 and 10:1 and wherein at least 90% of the outer surface is in contact with said coating.

23. The coated substrate of claim 13, wherein said polymeric substrate comprises a surface modified thermoplastic polymer characterized by at least 100 lower water contact angle, compared to a similar polymeric substrate comprising a pristine thermoplastic polymer; and wherein the surface modified polymer is characterized by a water contact angle of less than 70°.

24. (canceled)

25. (canceled)

26. The coated substrate of claim 13, wherein said thermoplastic polymer is selected from the group consisting of: polyacrylonitrile, polyether sulfone, polysulfone, cellulose acetate, polyvinylidene fluoride, polybenzimidazole, polymer of intrinsic microporosity, and a polyolefin, including any combination and any copolymer thereof.

27. (canceled)

28. The coated substrate of claim 13, wherein said particles are crystalline framework structures (CFS) particles; wherein said CFS particles comprise a zeolite, a metal-organic frameworks (MOF), and a covalent organic framework (COF); wherein said outer surface of said coating is characterized by a water contact angle between about 5° and about 50°; and is further characterized by reduced microbial attachment thereto, compared to a similar substrate devoid of said coating.

29. (canceled)

30. (canceled)

31. (canceled)

32. A membrane comprising the coated substrate of claim 13.

33. The membrane of claim 32, being a water filtration membrane characterized by a thickness of between 10 and 1000 μm.

34. The membrane of claim 32, wherein said membrane is, characterized by at least one of: a pore size between 2 nm and 100 nm; flux recovery ratio of at least 70%; and oil rejection of at least 95%, optionally wherein said membrane is an ultrafiltration membrane; and wherein said membrane retains at least 90% of the initial particles content upon successive water treatment cycles.

35.-37. (canceled)
